(19) United States
(12) Patent Application Publication
(10) Pub. No.: US 2026/0338734 A1
(43) Pub. Date: Oct. 29, 2026

(54) ION MOBILITY SEPARATORS

(71) Applicant: Micromass UK Limited, Wilmslow (GB)

(72) Inventors: Martin Raymond Green, Bowdon (GB); Jason Lee Wildgoose, Stockport (GB)

(73) Assignee: Micromass UK Limited, Wilmslow (GB)

(21) Appl. No.: 19/486,784

(22) PCT Filed: May 22, 2024
(86) PCT No.: PCT/GB2024/051326

§ 371 Date: Nov. 21, 2025

(30) Foreign Application Priority Data
May 24, 2023 (GB) 2307803.3
Oct. 4, 2023 (GB) 2315191.3

(51) Int. Cl. G01N 27/622; H01J 49/00; H01J 49/06

(52) U.S. Cl. CPC G01N 27/622; H01J 49/0031; H01J 49/065

(57) ABSTRACT

A method of mass and/or mobility spectrometry comprising: providing an ion separation device comprising a plurality of electrodes; providing a first force that urges ions in a first direction along an axis of the ion separation device, whilst also providing a second force that urges ions in a second opposite direction such that ions of different mobility or mass to charge ratio reach different equilibrium positions at different locations along the axis; and varying the first and/or second force during a single elution cycle of the ion separation device so as to sequentially release ions from said ion separation device in increasing order of ion mobility or mass to charge ratio, or in decreasing order of ion mobility or mass to charge ratio; wherein said varying step is performed such that ions in a first range of mobilities or mass to charge ratios elute from the ion separation device at a first rate, and ions in a second separate range of mobilities or mass to charge ratios elute from the ion separation device at a second different rate during said elution cycle.

### CROSS-REFERENCE TO RELATED APPLICATION

This application claims priority from and the benefit of United Kingdom patent application No. 2307803.3 filed on 24 May 2023 and United Kingdom patent application No. 2315191.3 filed on 4 Oct. 2023. The entire contents of these applications are incorporated herein by reference.

### FIELD OF THE INVENTION

The present invention relates generally to techniques for separating ions according to a physicochemical property such as ion mobility, or mass to charge ratio.

### BACKGROUND

An ion mobility separator (IMS) is a known device for separating ions according to their mobility through a gas. An example of such an IMS device is a drift tube IMS device. These devices have an ion trap that pulses a packet of ions into a drift tube that has a background gas therein. A static DC electric field is maintained along the drift tube so as to urge the ions through the gas from the upstream end, near the ion trap, to a downstream end. Ions of different mobility will have different transit times through the gas to the exit of the drift tube and hence are separated according to their mobility.

Travelling wave IMS devices are also known. In these devices a DC potential is repeatedly travelled along the drift tube so as to urge the ions in the downstream direction towards the exit of the drift tube, rather than providing a static DC electric field along the drift tube for urging the ions. Ions having different mobilities are urged downstream by different amounts each time that they are passed by a travelling DC potential. As such, the travelling DC potentials cause the ions to become separated and exit the IMS device at different times based on their mobility.

Other types of IMS devices are known that separate ions according to ion mobility, using opposing forces, and then release the ions from the ion trap in order of mobility.

### SUMMARY

The present invention provides a method of mass and/or mobility spectrometry comprising: providing an ion separation device comprising a plurality of electrodes; providing a first force that urges ions in a first direction along an axis of the ion separation device, whilst also providing a second force that urges ions in a second opposite direction such that ions of different mobility or mass to charge ratio reach different equilibrium positions at different locations along the axis; and varying the first and/or second force during a single elution cycle of the ion separation device so as to sequentially release ions from said ion separation device in increasing order of ion mobility or mass to charge ratio, or in decreasing order of ion mobility or mass to charge ratio; wherein said varying step is performed such that ions in a first range of mobilities or mass to charge ratios elute from the ion separation device at a first rate, and ions in a second separate range of mobilities or mass to charge ratios elute from the ion separation device at a second different rate during said elution cycle.

The first range of mobilities may correspond to mobility values that extend over a range having a first width and the second range of mobilities may correspond to different, non-overlapping mobility values that extend over a range having a second width that is the same as the first width. Said varying step causes the second range to elute from the ion separation device over a shorter period of time than the first range elutes from the ion separation device.

Ions may be prevented from entering the ion separation device during said single elution cycle.

The method may comprise selecting said first range of mobilities or mass to charge ratios to be mobilities or mass to charge ratios of interest, and selecting said second range of mobilities or mass to charge ratios to be mobilities or mass to charge ratios of less interest, and performing said varying step such that the first rate is slower than the second rate.

The method may comprise applying voltages to said electrodes so that DC potentials travel along the ion separation device so as to provide the first force that urges the ions in the first direction, and applying voltages to said electrodes so as to provide a DC electric field that provides the second force that urges the ions in the second direction. Alternatively, the method may comprise applying different phases of a periodic or harmonic voltage waveform to different ones of the electrodes so that potentials travel along the ion separation device so as to provide the first force that urges the ions in the first direction, and applying voltages to said electrodes so as to provide a DC electric field that provides the second force that urges the ions in the second direction. The voltage waveform may be an AC voltage waveform. The voltage waveform may be any periodic or harmonic wave including, but not limited to, a sine or cosine wave, a square wave, a trapezoidal wave, a triangular wave or a sawtooth wave. The voltage waveform may be a waveform that has a continuously varying amplitude.

The method may comprise varying the magnitude of the DC electric field as a function of position along the axis and/or varying at least one operational parameter of the potentials that travel along the ion separation device as a function of position along the axis, such that ions of different mobility or mass to charge ratio become trapped at said different equilibrium positions.

Embodiments are contemplated in which there is substantially no gas flow through the ion mobility separator. Other embodiments are contemplated in which a gas flow is additionally provided in the first or second direction in order to augment the ion separation, or in which the gas flow is provided instead of the travelling potentials or static electric field.

Said varying step may be performed such that the first and/or second force is varied progressively and substantially continuously so as to cause ions having said first range of mobilities or mass to charge ratios to exit the ion separation device, and wherein the first and/or second force is varied progressively and substantially continuously so as to cause ions having said second range of mobilities to exit the ion separation device.

The first and/or second force may be varied at a substantially constant rate so as to cause ions having said first range of mobilities or mass to charge ratios to exit the ion separation device. Additionally, or alternatively, the first and/or second force may be varied at a substantially constant rate so as to cause ions having said second range of mobilities or mass to charge ratios to exit the ion separation device.

Alternatively, said varying step may be performed such that the first and/or second force is varied progressively and substantially continuously so as to cause ions having said first range of mobilities or mass to charge ratios to exit the ion separation device; and wherein the first and/or second force is varied in a discontinuous and stepped manner so as to cause ions having at least some other mobilities or mass to charge ratios to exit the ion separation device.

The first and/or second force may be varied in a discontinuous and stepped manner so as to cause ions having said second range of mobilities to exit the ion separation device.

The method may comprise providing an ion-optical device downstream of the ion separation device for receiving ions eluting from the ion separation device; wherein the ion-optical device operates in a cyclical manner that is synchronised with the elution cycle of the ion separation device.

The operation of the ion-optical device may be synchronised with the start of the elution cycle, or with the start of the duration over which the first range of mobilities or mass to charge ratios elute from the ion separation device.

It will be appreciated that various embodiments are described herein that do not require the step of varying the first and/or second force such that ions in a first range of mobilities or mass to charge ratios elute from the ion separation device at a first rate, and ions in a second separate range of mobilities or mass to charge ratios elute from the ion separation device at a second different rate during the elution cycle. Accordingly, this feature is not essential to all of the embodiments.

Rather, the present invention relates more generally to a method of mass and/or mobility spectrometry comprising: providing an ion separation device comprising a plurality of electrodes; providing a first force that urges ions in a first direction along an axis of the ion separation device, whilst also providing a second force that urges ions in a second opposite direction such that ions of different mobility or mass to charge ratio reach different equilibrium positions at different locations along the axis; and varying the first and/or second force during a single elution cycle of the ion separation device so as to sequentially release ions from said ion separation device in increasing order of ion mobility or mass to charge ratio, or in decreasing order of ion mobility or mass to charge ratio. Various embodiments are described in the specific description.

The present invention also provides a method of mass and/or mobility spectrometry comprising: separating an analytical sample with a chromatography device such that different analytes in the analytical sample have different retention times in the chromatography device; ionising the analytes downstream of the chromatography device to form ions; receiving the ions, or ions derived therefrom, in an ion mobility separator; and operating the ion mobility separator so as to repeatedly alternate between: (i) an accumulation mode in which it receives and separates ions by mobility; and (ii) an elution mode in which ions are caused to elute from the ion mobility separator in increasing or decreasing order of mobility; wherein the ion mobility separator is synchronised with the chromatography device such that, during a single separation cycle of the chromatography device, different ones of the accumulation modes and/or different ones of the elution modes are operated differently at different retention times of the chromatography device.

The chromatography device may be a liquid or gas chromatography device.

The mobility separator may be operated with different operational parameters in said different accumulation modes so as to confine ions having different mobility ranges in said different accumulation modes.

The operational parameters of the ion mobility separator may therefore be optimised for each mobility range that is confined in each respective accumulation mode.

Additionally, or alternatively, the different elution modes may be operated differently such that the elution is optimised for the ranges of mobilities that elute in each respective accumulation mode.

The ion mobility separator may be synchronised with the chromatography device such that during a first elution mode that occurs at a first retention time of the chromatography device, mobilities are caused to elute from the ion separation device at a first rate; and such that during a second elution mode that occurs at a second different retention time of the chromatography device, mobilities are caused to elute from the ion separation device at a second rate.

The first elution mode may occur over a first duration and the second elution mode may occur over a different duration.

This enables, for example, analytes of interest that are expected to elute from the chromatography device at the second retention time to be eluted from the IMS device over a relatively long duration, e.g. at a slower rate and higher mobility resolution.

The ion mobility separator may be synchronised with the chromatography separator such that the operation of the ion mobility separator is varied as a function of the retention time of the chromatography separator in a preselected manner.

The method may comprise performing a survey scan mode in which the analytical sample is separated in the chromatography separator, ionised and the resulting ions, or ions derived therefrom are analysed using the ion mobility separator so as to determine their mobilities as a function of retention time in the chromatography separator; selecting ions having a restricted range of the determined mobilities as being target ions of interest; and then analysing the analytical sample again using the method described above, during which the ion mobility separator is synchronised with a separation cycle of the chromatography separator such that: (i) at the time the target ions of interest arrive at the ion mobility separator, the ion mobility separator is controlled to operate in an accumulation mode that substantially only confines the target ions of interest or that is otherwise optimised for the target ions of interest; and/or (ii) when the target ions of interest are in the ion mobility separator, the ion mobility separator is operated in an elution mode that elutes ions over a longer duration than in elution modes that occur at other retention times of the chromatography device at which the target ions of interest are not expected to be in the ion mobility separator.

Each accumulation mode may comprise providing a first force that urges ions in a first direction along an axis of the ion separation device, whilst also providing a second force that urges ions in a second opposite direction such that ions of different mobility reach different equilibrium positions at different locations along the axis; and each elution mode may comprise varying the first and/or second force so as to sequentially release ions from said ion separation device in increasing order of ion mobility or mass to charge ratio, or in decreasing order of ion mobility or mass to charge ratio.

The method may comprise applying voltages to electrodes of the ion mobility separator so that potentials travel along the ion mobility separator so as to provide the first force that urges the ions in the first direction, and applying voltages to said electrodes so as to provide a DC electric field that provides the second force that urges the ions in the second direction. The potentials that travel along the ion mobility separator may be DC potentials or may be generated by applying different phases of a periodic or harmonic voltage waveform to different electrodes of the ion separation device. The voltage waveform may be any periodic or harmonic wave including, but not limited to, a sine or cosine wave, a square wave, a trapezoidal wave, a triangular wave or a sawtooth wave. The voltage waveform may be a waveform that has a continuously varying amplitude.

The method may comprise selecting the magnitude of the DC electric field and/or at least one operational parameter of the travelling potentials that is applied to the ion separation device based on the retention time of the chromatography device.

The values may be selected so as to optimise the mobility separation of the target ions of interest and/or to minimize distortions due to space-charge effects at this specific chromatographic retention time.

The method may comprise providing an ion-optical device downstream of the ion separation device for receiving ions eluting from the ion separation device; wherein the ion-optical device operates in a cyclical manner that is synchronised with the elution cycle of the ion separation device.

The present invention also provides a method of mass and/or mobility spectrometry comprising: providing an ion separation device comprising a plurality of electrodes; operating the ion separation device in a first mode in which a DC electric field or travelling potentials are used to urge ions through a substantially stationary background gas such the ions are separated according to mobility through the gas; and operating the ion separation device in a second mode in which a first force urges ions in a first direction along an axis of the ion separation device, whilst also providing a second force that urges ions in a second opposite direction such that ions of different mobility reach different equilibrium positions at different locations along the axis.

In the first mode ions need not be confined axially during the mobility separation and so the ion separation device may separate ions relatively quickly. In contrast, ions may be separated more slowly and/or with higher mobility resolution in the second mode.

The second mode may further comprise varying the first and/or second force so as to sequentially release ions from said ion separation device in increasing order of ion mobility or mass to charge ratio, or in decreasing order of ion mobility or mass to charge ratio.

The potentials that travel along the ion mobility separator may be DC potentials or may be generated by applying different phases of a periodic or harmonic voltage waveform to different electrodes of the ion separation device. The voltage waveform may be any periodic or harmonic wave including, but not limited to, a sine or cosine wave, a square wave, a trapezoidal wave, a triangular wave or a sawtooth wave. The voltage waveform may be a waveform that has a continuously varying amplitude.

The method may comprise applying voltages to electrodes of the ion mobility separator so that potentials travel along the ion mobility separator so as to provide the first force that urges the ions in the first direction, and applying voltages to said electrodes so as to provide a DC electric field that provides the second force that urges the ions in the second direction.

The present invention also provides an ion mobility and/or mass spectrometer configured with control circuitry for performing any of the methods described herein.

The present invention also provides a method of mass spectrometry comprising: providing ions to an ion separation device comprising a plurality of electrodes; operating the ion separation device under a first set of operating conditions in a first mode such that the ions are separated and elute from the ion separation device according to their mass to charge ratios; and operating the ion separation device under a second, different set of operating conditions in a second mode such that ions are separated and elute from the ion separation device according to their mobilities; wherein the ion separation device is switched between the first and second modes during a single experimental run.

The ion separation device is switched between the first and second modes during a single experimental run, e.g. whilst analyte ions are being substantially continually supplied into the mass spectrometer performing the method.

The ion separation device may separate ions in each of the first and second modes by: providing a first force that urges ions in a first direction along an axis of the ion separation device, whilst also providing a second force that urges ions in a second opposite direction such that ions of different mass to charge ratio or mobility reach different equilibrium positions at different locations along the axis; and varying the first and/or second force so as to cause ions to elute from said ion separation device in increasing order of mass to charge ratio or mobility, or in decreasing order of mass to charge ratio or mobility.

The method may comprise: (i) applying voltages to said electrodes so that DC potentials travel along the ion separation device so as to provide the first force that urges the ions in the first direction, and applying voltages to said electrodes so as to provide a DC electric field and/or providing a gas flow so as to provides the second force that urges the ions in the second direction; or (ii) applying different phases of a periodic or harmonic voltage waveform to different ones of the electrodes so that potentials travel along the ion separation device so as to provide the first force that urges the ions in the first direction, and applying voltages to said electrodes so as to provide a DC electric field and/or providing a gas flow so as to provide the second force that urges the ions in the second direction.

The first set of conditions may be such that the ions lose a relatively small portion of their kinetic energy between being accelerated by successive potentials that travel along the ion separation device, such that the ions do not reach a mobility-related terminal velocity; and the second set of conditions may be such that the ions lose a greater proportion of their kinetic energy between being accelerated by successive potentials that travel along the ion separation device, such that the ions reach a mobility-related terminal velocity due to collisions with the gas inside the ion separation device.

One or more of the following conditions may differ in the first set of conditions as compared to the second set of conditions: (i) the gas pressure in the ion separation device; (ii) the gas type in the ion separation device; (iii) the gas composition in the ion separation device; and (iv) the speed that the potentials that travel along the ion separation device.

For example, the gas pressure in the ion separation device may be lower in the first set of conditions than in the second set of conditions.

The gas inside the ion separation device may have a lower molecular mass in the first set of conditions than in the second set of conditions.

The speed at which the potentials travel along the ion separation device may be higher in the first set of conditions than in the second set of conditions.

The ion separation device may be switched between the first and second modes repeatedly.

The method may comprise operating the ion separation device so as to repeatedly perform a cycle that comprises: (i) an accumulation period in which the ion separation device receives ions; and (ii) an elution period in which ions are caused to elute from the ion separation device according to mass to charge ratio or mobility.

Ions may be prevented from entering the ion separation device during the elution period.

The ion separation device may be alternated between the first and second modes during the elution period of a single one of the cycles; or the ion separation device may be operated in the first mode during the elution period of one of the cycles and is operated in the second mode during the elution period of a different one of the cycles.

The method may comprise: a) performing a survey scan in which ions from an analytical sample are mass and/or mobility analysed; b) selecting one or more ion species detected in the survey scan as being one or more target ions species of interest; c) selecting that said one or more target ions species of interest should be analysed using either said first mode or said second mode; and then d) analysing the analytical sample again using the method described above, during which the one or more target ions species of interest are analysed according to the mode selected in step c).

Each of the survey scan and step d) may include separating the sample by chromatography (e.g. liquid chromatography), ionising the separated sample and then mass and/or mobility analysing the resulting ions. The elution time of the target ion species of interest from the chromatography device may be determined during the survey scan, and then step d) may control the ion separation device to operate in the selected mode for the target species of interest at the elution time of the target ion species of interest from the chromatography device.

The present invention also provides a mass spectrometer configured to perform the above methods. Accordingly, the present invention provides a mass spectrometer comprising: an ion separation device comprising a plurality of electrodes; and control circuitry configured to control the ion separation device to operate under a first set of operating conditions in a first mode such that the ions are separated and elute from the ion separation device according to their mass to charge ratios, and operate under a second, different set of operating conditions in a second mode such that ions are separated and elute from the ion separation device according to their mobilities; wherein the control circuitry is configured to switch the ion separation device between the first and second modes during a single experimental run.

The present invention also provides a method of mass spectrometry comprising: separating ions in an ion separation device comprising a plurality of electrodes by providing a first force that urges the ions in a first direction along an axis of the ion separation device, whilst also providing a second force that urges ions in a second opposite direction such that ions of different mass to charge ratio reach different equilibrium positions at different locations along the axis, and varying the first and/or second force so as to perform a separation cycle in which ions are sequentially released from said ion separation device in increasing or decreasing order of mass to charge ratio; and mass filtering the ions released from the ion separation device in a first mass filter; wherein the mass transmission window of the first mass filter is scanned and/or stepped in synchronism with the separation cycle of the ion separation device.

This enables the method to be performed with a relatively high duty cycle, since the ion separator provides different mass to charge ratio ions to the mass filter at different times, and so the mass filter filters out fewer ions at any given time.

The mass transmission window may be substantially continuously scanned across a range of mass to charge ratios and/or discontinuously stepped across a range of mass to charge ratios.

The method may comprise: (i) applying voltages to said electrodes so that DC potentials travel along the ion separation device so as to provide the first force that urges the ions in the first direction, and applying voltages to said electrodes so as to provide a DC electric field and/or providing a gas flow so as to provide the second force that urges the ions in the second direction; or (ii) applying different phases of a periodic or harmonic voltage waveform to different ones of the electrodes so that potentials travel along the ion separation device so as to provide the first force that urges the ions in the first direction, and applying voltages to said electrodes so as to provide a DC electric field and/or providing a gas flow so as to provide the second force that urges the ions in the second direction.

The method may comprise separating ions according to mobility in an ion mobility separator, supplying the mobility separated ions to said ion separation device and then performing said step of separating ions in the ion separation device.

Said ions may include one or more ion species having multiple different conformers that have different respective mobilities.

Due to the nature of the ion separation device, a given ion species that has different conformers will elute from the ion separation device as a relatively narrow peak. As such, the ion separation device enables the first mass filter to isolate a greater number of different ion species during the separation cycle of the ion separation device.

The method may comprise mass filtering the ions between the ion mobility separator and the ion separation device using a second mass filter such that only ions having a restricted mass to charge ratios and mobilities in restricted ranges are transmitted to the ion separation device. For example, this may be performed such that only ions having restricted charge states are transmitted to the ion separation device, e.g. only multiply charged ions may be transmitted to the ion separation device whereas singly charged ions are filtered out.

The ions that are transmitted by the second mass filter may be transmitted into a fragmentation or reaction device and fragmented or reacted so as to produce fragment ions or other product ions. These fragment or other product ions may then be mass analysed.

The present invention also provides a mass spectrometer configured to perform the above methods. Accordingly, the present invention provides a mass spectrometer comprising: an ion separation device comprising a plurality of electrodes; a first mass filter; and control circuitry configured to: operate the ion separation device so as to separate ions by providing a first force that urges the ions in a first direction along an axis of the ion separation device, whilst also providing a second force that urges ions in a second opposite direction such that ions of different mass to charge ratio reach different equilibrium positions at different locations along the axis, and vary the first and/or second force so as to perform a separation cycle in which ions are sequentially released from said ion separation device in increasing or decreasing order of mass to charge ratio; and control the first mass filter to mass filter the ions released from the ion separation device, wherein the mass transmission window of the first mass filter is scanned and/or stepped in synchronism with the separation cycle of the ion separation device.

### BRIEF DESCRIPTION OF THE DRAWINGS

Various embodiments of the present invention will now be described, by way of example only, and with reference to the accompanying drawings in which:

FIGS. 1A-1D shows a schematic of an IMS device according to an embodiment of the present invention;

FIG. 2 shows a simulation of the intensity with which ions elute an IMS device as a function of time when a gas flow through the IMS device is used and a simulation for when there is no gas flow;

FIGS. 3A-3C show various embodiments of electrodes that may be used to form the IMS device;

FIG. 4 shows a schematic of an embodiment in which first and second IMS devices are provided in series;

FIG. 5 shows a schematic of an embodiment in which first and second IMS devices are provided in parallel;

FIG. 6 shows another embodiment in which IMS devices are provided in parallel;

FIGS. 7A-7D show data from an ion separator operating in a mode in which ions are separated predominantly according to ion mobility;

FIGS. 8A-8D show data from an ion separator operating in a mode in which ions are separated predominantly according to mass to charge ratio;

FIG. 9A shows an elution time chromatogram obtained when using the ion separation device in the mode described in relation to FIGS. 8A-8D, whereas FIG. 9B shows an elution time chromatogram obtained when using the ion separation device in the mode described in relation to FIGS. 7A-7D; and

FIG. 10 shows an embodiment in which an ion separation device is operated predominantly as a mass to charge ratio separator.

### DETAILED DESCRIPTION

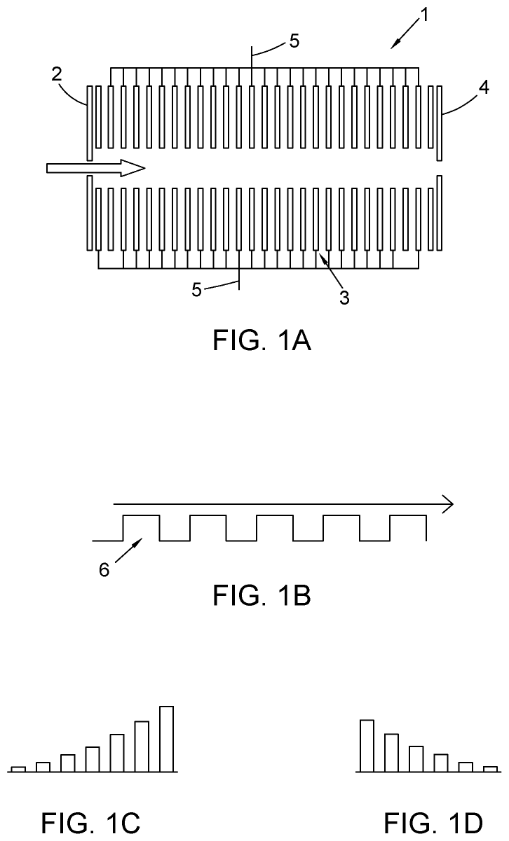

Embodiments of the invention employ at least one ion mobility separator (IMS) device that separates ions according to their mobility through a background gas that is present in the IMS device. Each of the at least one IMS devices uses voltages to apply forces on the ions in opposing directions so as to cause the ions to separate according to their mobility. FIG. 1A shows a schematic of such an IMS device.

FIG. 1A shows an IMS device 1 having an entrance electrode 2, a series of intermediate electrodes 3 that form an ion guide and an exit electrode 4. Opposite phases of an RF voltage supply 5 may be applied to different, e.g. axially alternate, electrodes of the ion guide in order to produce a pseudo-potential that confines the ions radially within the IMS device. DC voltages are transiently applied to axially successive electrodes of the ion guide at successive respective times so as to provide DC potentials 6, as shown in FIG. 1B, that repeatedly travel along the length of the ion guide in a first direction. These travelling DC potentials urge the ions in the first direction as they pass the ions. DC voltages are also applied to electrodes of the ion guide so as to provide a DC electric field that urges the ions in a second axial direction, that is opposite to the first direction, along the IMS device.

The magnitude of the DC electric field may vary as a function of position along the axial length of the IMS device such that when the ions are driven against this electric field by the travelling DC potentials the ions separate out along the axis of the IMS device according to their ion mobility. For example, the amplitude of the electric field may increase in magnitude as a function of increasing distance in the first direction along the IMS device. Ions having different mobilities may be axially confined at different respective axial equilibrium positions along the IMS device where the force on them due to the electric field is counter-balanced with the time-averaged force on them due to the travelling DC potentials.

Additionally, or alternatively, to the magnitude of the electric field varying as a function of position along the axial length of the IMS device (e.g. the magnitude of the electric field could be constant along the IMS device), one or more parameter of each DC potential that is travelled along the IMS device may vary as a function of position along the axial length of the IMS device, such that when the ions are driven against the electric field by the travelling DC potentials the ions separate out along the axis of the IMS device according to their ion mobility. For example, the amplitude or speed of the DC travelling potential may vary as a function of position along the IMS device. For instance, each time a DC potential is travelled along the IMS device in the first direction, it may increase or decrease in amplitude, e.g. as shown in FIGS. 1C and 1D and/or increase in speed as it travels in the first direction. Again, ions having different mobilities may be axially confined at different respective axial equilibrium positions along the IMS device where the force on them due to the electric field is counter-balanced with the time-averaged force on them due to the travelling potentials.

When the ions have been separated according to mobility within the IMS device, the ions may be caused to elute from the exit of the IMS device by progressively varying the magnitude of the DC electric field and/or by progressively varying at least one property of the travelling DC potentials (such as amplitude and/or speed).

For example, if the first direction is the downstream direction towards the exit of the IMS device, ions may be caused to elute from the exit of the IMS device by progressively varying a property of the DC potential that is being repeatedly travelled along the IMS device, such that the DC potential pushes ions to elute from the IMS device in the first direction in order of mobility as time progresses (e.g. in order of progressively lower mobility). For example, the amplitude of the DC potential may be progressively increased (e.g. being larger at any given point along the ion guide in the elution mode, as compared to when being operated in the trapping mode prior to ions eluting). Alternatively, or additionally, the speed of the DC potential in the first direction may be progressively decreased (e.g. being lower at any given point along the ion guide in the elution mode, as compared to when being operated in the trapping mode prior to ions eluting).

Additionally, or alternatively, if the second direction is the upstream direction towards the entrance of the IMS device, ions may be caused to elute from the exit of the IMS device by progressively varying the magnitude of the electric field (e.g. being smaller at any given point along the ion guide in the elution mode, as compared to when being operated in the trapping mode prior to ions eluting).

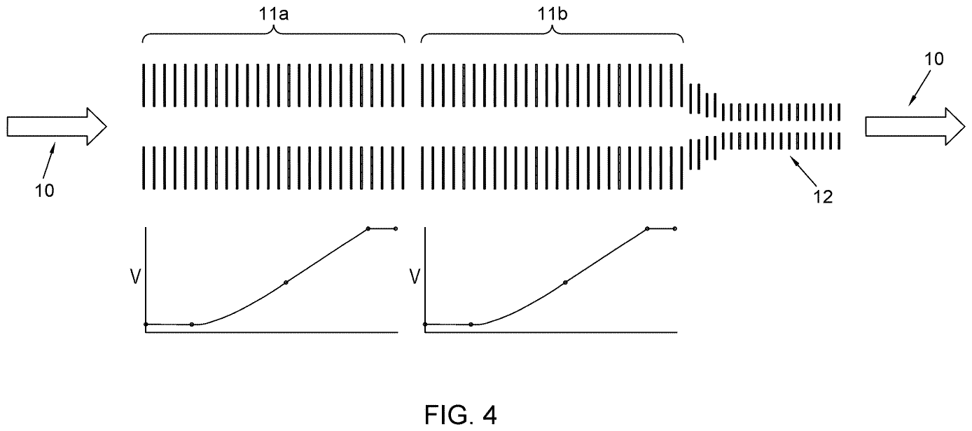

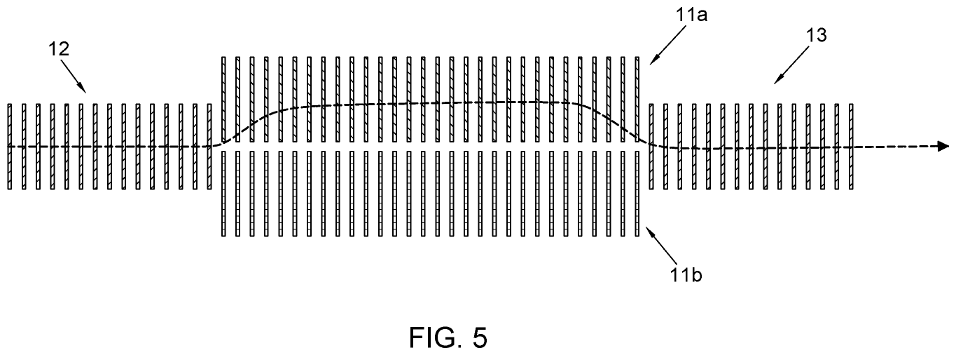

As described above, the magnitude of the electric field that urges ions in the second direction may increase with increasing position along the IMS device in the first direction. The magnitude of the electric field may increase as a function of position in this manner until an axial location at which it is at its maximum magnitude. The magnitude of the electric field may then remain substantially constant over the length of the IMS device from said axial location to the exit. As also described above, the travelling DC potentials travel along the IMS device, including along the length of the IMS device from said axial location to the exit. This enhances the ion mobility resolution of the IMS device. The IMS device may therefore be operated as described in WO 2021/053342, which is incorporated herein by reference, such as for instance in relation to FIG. 4 of that document.

For the avoidance of doubt, in the above-described embodiments the first direction is the downstream direction in which ions are caused to elute from each IMS device, which corresponds to the direction from the ion source to an ion detector in the spectrometer. However, alternatively, it is contemplated that the second direction may be the downstream direction, i.e. such that it is the static electric field that urges the ions to elute from the IMS device rather than the travelling DC potentials.

As described above, the magnitude of the DC electric field may vary as a function of axial position over at least part of the length of the IMS device, e.g. such that ions of different mobilities reside at different equilibrium positions along the IMS device. The magnitude of the DC electric field may vary as a function of position along the IMS device in a substantially smooth manner, i.e. such that it varies substantially continuously and progressively as a function of position (over the whole of the length of the IMS device in which the magnitude varies). For example, the gradient of the magnitude of the electric field may be substantially linear over the whole of the length of the IMS device in which the magnitude varies.

Alternatively, the magnitude of the DC electric field may vary as a function of position along the IMS device in a manner such that it does not vary substantially continuously and progressively as a function of position (within the length of the IMS device in which the magnitude varies). For example, the magnitude of the electric field may step discontinuously between two different values at one or more positions along the length of the IMS device. For instance, the IMS device may have first and second axial lengths that are directly axially adjacent to each other, where the magnitude of the electric field has a first linear gradient over the first axial length and a second linear gradient over the second axial length, and where the magnitude of the electric field steps up discontinuously at the boundary between the first and second axial lengths. The first and second linear gradients may be the same gradient or different gradients.

It is contemplated that rather than the first and second axial lengths being directly adjacent to each other, a third axial length may be provided between them. The magnitude of the electric field may have a third linear gradient over the third axial length, where the third axial gradient is different to both the first and second axial gradients.

Similarly, in embodiments in which a property of the traveling DC potential (e.g. its amplitude and/or speed) varies as a function of position along the length of the IMS device, the property may vary in a substantially smooth manner (i.e. such that it varies substantially continuously and progressively as a function of position), over the whole of the length of the IMS device in which the property varies. Alternatively, the property of the traveling DC potential may vary as a function of position along the IMS device in a manner such that it does not vary substantially continuously and progressively as a function of position (over the length of the IMS device in which the property varies). For example, the amplitude of the travelling DC potential may step up or down discontinuously at one or more positions along the length of the IMS device as it moves in the first direction. Similarly, the speed of the travelling DC potential may step up or down discontinuously at one or more positions along the length of the IMS device as it moves in the first direction.

As described above, the magnitude of the electric field and/or a property of the travelling DC potential may be varied with time in order to cause ions to elute from the exit of the IMS device such that ions having different mobilities elute at different respective times. The magnitude and/or said property may be varied progressively and substantially continuously until ions having a pre-selected range of mobilities of interest, or all of the ions, have eluted from the IMS device. Alternatively, the magnitude and/or said property may be varied in a discontinuous and stepped manner until ions having a pre-selected range of mobilities of interest, or all of the ions, have eluted from the IMS device.

In alternative embodiments, the magnitude and/or said property may be varied progressively and substantially continuously whilst a portion of the ions in the IMS device elute, and the magnitude and/or said property may be varied in a discontinuous and stepped manner whilst different portion of the ions in the IMS device elute. For example, the magnitude and/or said property may be varied progressively and substantially continuously whilst a first range of mobilities of interest elute from the IMS device, and then the magnitude and/or said property may be discontinuously stepped to a value so as to cause a second range of mobilities of interest to begin to elute from the IMS device (where the first and second ranges of mobilities are separated from each other by an intermediate range of mobilities). The magnitude and/or said property may then be varied progressively and substantially continuously whilst the second range of mobilities of interest elute from the IMS device.

It is contemplated that the magnitude of the electric field and/or said property of the travelling DC potential may be varied with time at a substantially constant rate or at a varying rate, whilst at least some of the ions elute from the IMS device. For example, the magnitude of the electric field and/or said property of the travelling DC potential may be varied at a first average rate whilst ions having one range of mobilities elute from the IMS device (e.g. a preselected range of mobilities of interest), and may be varied at a second, relatively higher average rate whilst ions having another range of mobilities elute from the IMS device (e.g. a range of mobilities that has not been identified as being of interest or a preselected range of mobilities that has been identified as not being of interest). The rate at which the magnitude and/or said property is varied whilst ions having said one range of mobilities elute from the IMS device may be constant and/or the rate at which the magnitude and/or said property is varied whilst ions having said another range of mobilities elute from the IMS device may be constant. These embodiments enable ions having said one range of mobilities (e.g. mobilities of interest) to elute from the IMS device with a relatively high mobility resolution. Alternatively, or additionally, these embodiments enable the operation of an ion-optical device downstream of the IMS device to be synchronised with the IMS device relatively easily, i.e. the operation of the downstream device has more time to be varied whilst the ions having said one range of mobilities (e.g. mobilities of interest) elute from the IMS device.

It is contemplated that the IMS device may separate the ions according to mobility, and cause them to elute, with substantially no gas flow in the first and/or second directions. This is useful in arrangements in which it is not practical to maintain a high gas flow rate through the IMS device, e.g. because the cross-sectional area inside the IMS device is relatively large.

Alternatively, a gas flow also be provided through the IMS device in the first or second direction in order to urge the ions. This gas flow may be used to enhance the mobility resolution of the mobility separation. For example, the gas flow may be provided such that the gas flows through the IMS device in the second direction, so as to urge the ions in the same direction that the ions are urged by the static DC electric field. Adding the gas flow in this manner increases the axial length of the IMS device over which a given range of mobilities reside and therefore provides a higher mobility resolution.

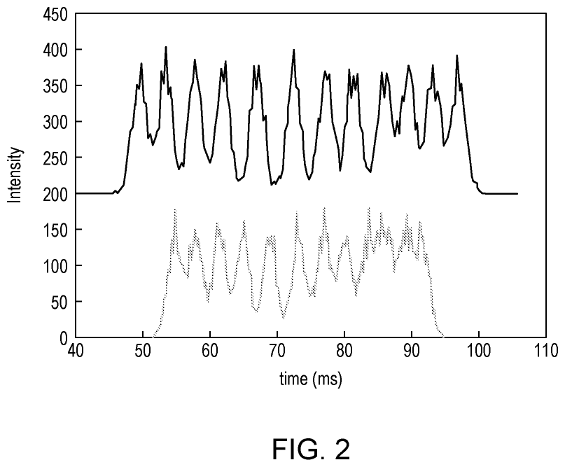

FIG. 2 shows a simulation of the intensity with which the same ions elute from the exit of an IMS device as a function of time when a gas flow is used (top plot) and when a gas flow is not used (bottom plot). The data for the top plot was obtained by simulating an IMS device operating at a pressure of 2 Torr, where the travelling DC potentials have an average speed in the first direction of 200 m/s, where the DC electric field in the second direction had a constant magnitude along the length of the IMS device of 0.7 V/mm, where the gas flow in the second direction has a speed of 10 m/s, and where the amplitude of the travelling DC potentials is varied in order to cause ions to elute from the IMS device. The data for the bottom plot was obtained by simulating the same conditions except that that no gas flow was present and the magnitude of the DC electric field was 1 V/mm. It can be seen that with a relatively small gas flow through the IMS device the mobility resolution is improved. In this example, the magnitude of the DC electric field was reduced when obtaining the data for the bottom plot such that the same mobility range eluted for both plots.

Dopants may be provided in the background gas of the IMS device such that the dopants interact with the analyte ions and modify their mobility. For example, if different analyte ion species are expected or known to be present that have the same or similar mobilities, then a dopant may be provided that modifies the mobility of only one, or both, of the different ion species such that the different species then have a greater difference between their mobilities than before their interaction with the dopant. It will be appreciated that the different species will then elute from the IMS device at significantly different times, i.e. they may be resolved by the IMS device.

Alternatively, or additionally, the background gas in the IMS device may comprise a polarisable gas or vapour of organic molecules having a permanent dipole, such that the analyte ions are caused to separate based on more than solely their interaction with the background gas due to their physical cross-sectional areas. The analyte ions may interact with the background gas via gas phase interactions that do not result in permanent chemical bonds. For example, ion selective molecule reactions may be performed in the IMS device. For instance, a substance may be added to the background gas of the IMS device as described in US 2016/0341696 or WO 2015/189552, each of which is incorporated herein by reference. Such techniques may be used when seeking to identify the analytes (e.g. by looking at a characteristic shift) or simply for separating the analytes.

Analyte ions may be confined in the IMS device by opposing forces, as described above. The ions may then be fragmented, or activated so as to change their conformation (substantially without the ions being fragmented), whilst they are confined within the IMS device. For example, the ions may be fragmented or activated by providing laser light, reactant ions, reactant neutral molecules, meta-stable compounds, or electrons into the IMS device. For example, the analyte ions may be subjected to ozonolysis, hydrogen deuterium exchange, charge stripping, electron transfer dissociation, or electron capture dissociation. Although the reactions have been described as being performed whilst the ions are confined, they could be performed during elution of ions from the IMS device. As the ions are separated spatially in the IMS device, the amount of energy used to cause the fragmentation or reaction may be different for the different ions. Additionally, or alternatively, the technique used to fragment or react the ions may be different for the different ions.

The ion confinement region of the IMS device described herein may be elongated along a central axis that is substantially parallel to the first and second directions. This enables ions to be separated by mobility by the DC electric field and travelling DC potentials such that they reside at their equilibrium positions that span a relatively large distance along the central axis. As such, the IMS device may confine the ions at a relatively low charge density and hence with relatively low space-charge effects. The analytical performance of the IMS device, such as mobility resolution, may therefore be relatively high. The use of DC travelling potentials to urge ions in the first direction in such an elongated device is particularly advantageous compared to the using a DC electric field to do this, as the maximum absolute voltage of the DC travelling potentials may be selected independently of the axial length of the IMS device. This is in contrast to the use of a DC electric field to urge ions in the first direction, which would obviously require a larger potential difference to be applied over a longer IMS device in order to maintain a given electric field magnitude along the device. Applying such a relatively large potential difference may be impractical, e.g. the relatively high potentials needed to achieve this may cause electrical discharges.

As described above in relation to FIG. 1, each IMS device 1 comprises electrodes 3 that radially confine the ions and to which DC voltages may be applied for axially separating the ions according to their mobility. These electrodes may be provided in the form of an ion tunnel ion guide, such as a stacked ring ion guide. Such ion guides may comprise a series of apertured electrodes that are axially spaced along the central axis of the IMS device in a manner such that the apertures are aligned. Each apertured electrode may have an aperture that is entirely surrounded by electrode material. Alternatively, each apertured electrode may be formed from multiple separate planar electrodes that are arranged together in the same plane so as to define the aperture between them. It is alternatively contemplated that the ion guide may be an axially segmented multipole ion guide, such as a quadrupole ion guide. In all of the above described embodiments, RF voltages may be applied to the electrodes of the ion guides so as to radially confine ions therein. DC voltages may also be applied to the electrodes so as to generate the DC electric field and DC travelling potentials described herein.

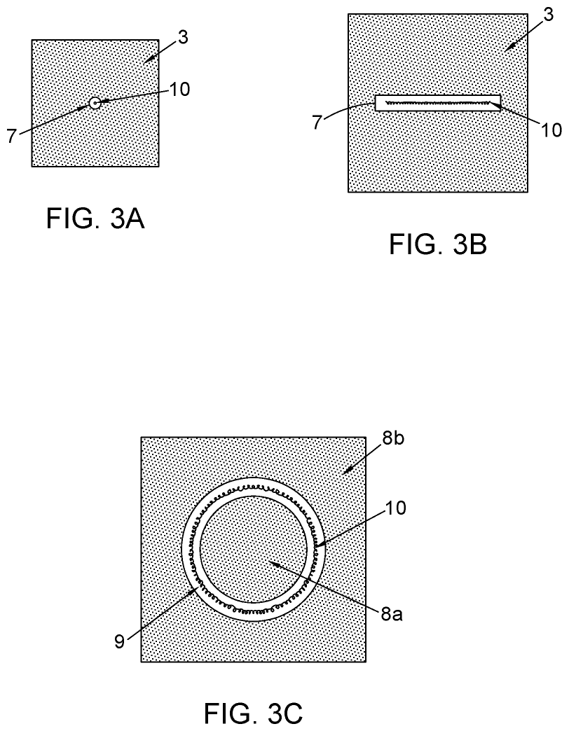

FIG. 3A shows a schematic of one of the electrodes 3 of an embodiment in which the ion guide is an ion tunnel ion guide. In this embodiment the ion guide comprises a plurality of plate electrodes, wherein each electrode has an aperture 7 therein and wherein the apertures of the electrodes are aligned along the central axis of the IMS device so as to form an ion guiding path. In the depicted embodiment the aperture is circular, although other cross-sectional shapes are contemplated, such as oval, square or an elongated rectangle. It may be particularly desirable to provide apertures that are each extended in one dimension (orthogonal to the central axis) by a greater amount than they are extended in an orthogonal dimension (also orthogonal to the central axis). This provides a relatively large cross-sectional area in which ions 10 can be confined efficiently and therefore provides a relatively high space-charge capacity for the IMS device. For example, each aperture may be an elongated slot, as shown in FIG. 3B.

The ion guide of the IMS device may have electrode configurations that define ion guiding paths having different cross-sectional shapes to those described above, e.g. as will be described with reference to FIG. 3C.

FIG. 3C shows a cross-sectional view through the ion guide in an embodiment in which each axial segment comprises an inner electrode 8a that is surrounded by an outer electrode 8b so as to define to define an annular ion guiding region 9 radially therebetween, i.e. an ion guiding region that extends circumferentially around the inner electrode. RF voltages may be applied to the inner and outer electrodes so as to maintain the ions 10 in the region therebetween. Although the depicted embodiment shows the inner electrodes as being circular and the outer electrode 2b as having a circular aperture so as to define an annular ion guiding region therebetween, it is contemplated that the inner and outer electrodes may be configured so as to provide a tubular ion guiding region of a different cross-sectional shape.

Embodiments are therefore contemplated in which the ion guiding region of the IMS device has a different cross-sectional shape of the upstream ion-optical component that feeds the ions into the IMS device and/or the downstream ion-optical component that receives the ions from the IMS device so as to provide the IMS device with a relatively high space charge capacity. However, it is contemplated that the ion guiding region of the IMS device may have the same cross-sectional shape as that of the upstream ion-optical component that feeds the ions into the IMS device and/or the downstream ion-optical component that receives the ions from the IMS device. In all of these embodiments, the ion guiding region may have a larger cross-sectional area than that of the upstream ion-optical component that feeds the ions into the IMS device and/or the downstream ion-optical component that receives the ions from the IMS device.

If the IMS device has a different cross-sectional shape and/or area than the upstream ion-optical component that feeds the ions into the IMS device, then an ion guiding device may be arranged between the IMS device and the upstream ion-optical component for guiding ions from the upstream ion-optical component into the IMS device. For example, an ion guiding device may be used to guide ions from an upstream ion-optical component that has an ion guiding region of a substantially circular cross-section into the IMS device that has an ion guiding region that has a substantially rectangular cross-section. In embodiments where the ion guiding region of the upstream ion-optical device has a larger cross-sectional area than the ion guiding region of the IMS device, the ion guiding device may be an ion funnel for funnelling ions from the upstream ion-optical device into the IMS device. Alternatively, in embodiments where the ion guiding region of the upstream ion-optical device has a smaller cross-sectional area than the ion guiding region of the IMS device, the ion guiding device may allow the ion cloud to expand as it travels from the upstream ion-optical device into the IMS device.

Similarly, an ion guiding device may be used to guide ions from an IMS device that has an ion guiding region that has a substantially rectangular cross-section into a downstream ion-optical component that has an ion guiding region of a substantially circular cross-section. In embodiments where the ion guiding region of the downstream ion-optical device has a smaller cross-sectional area than the ion guiding region of the IMS device, the ion guiding device may be an ion funnel for funnelling ions from the IMS device into the downstream ion-optical device. Alternatively, in embodiments where the ion guiding region of the downstream ion-optical device has a larger cross-sectional area than the ion guiding region of the IMS device, the ion guiding device may allow the ion cloud to expand as it travels from the IMS device into the downstream ion-optical device.

It is contemplated that two or more of the IMS devices of the type described above may be provided in the mass and/or mobility spectrometer. The multiple IMS devices may be provided in series, e.g. as shown in FIG. 4, or may be provided in parallel such as is shown in FIG. 5.

FIG. 4 shows a schematic of an arrangement in which first and second IMS devices 11a, 11b are provided in series. Ions 10 are received into an entrance end of the first IMS device 11a during an ion accumulation mode of the first device. The ions are axially confined within the first IMS device by the opposing forces on them, as discussed elsewhere herein. In the illustrated example, transient DC potentials are successively applied to successive electrodes arranged along the first IMS device such that DC travelling potentials repeatedly travel in the first direction (i.e. the downstream direction in this embodiment). Also, different DC potentials are applied to different electrodes along the IMS device so as to form a static electric field that urged ions in the second direction (i.e. the upstream direction in this embodiment). An example of the voltage profile along the first IMS device is shown below the first IMS device. The resulting electric field magnitude would start at zero at the upstream end of the IMS device, rise linearly and then remain constant over a length proximate the downstream end of the IMS device. The ions are therefore accumulated in the first IMS device in a manner such that they are axially confined at different axial location depending on their mobility.

When sufficient ions have been accumulated in the first IMS device, they are allowed to exit the downstream end of the first device and pass into the upstream end of the second IMS device 11b by switching the first IMS device to an ion ejection mode. Ions may or may not be prevented from entering the upstream end of the first IMS device during this mode, e.g. by providing an electric potential barrier at the entrance end of the first device. All of the ions may be urged out of the first device at substantially the same time, e.g. by removing the DC electric field acting in the upstream direction. Once the ions have exited the downstream end of the first IMS device, the first IMS device may switch back to the ion accumulation mode and ions are allowed to enter the upstream end of the first IMS device.

When the second IMS device receives ions from the first IMS device it is operated in an ion accumulation mode during which the ions are axially confined within the second IMS device by opposing forces on them, as discussed elsewhere herein. In the illustrated example, transient DC potentials are successively applied to successive electrodes arranged along the second IMS device such that DC travelling potentials repeatedly travel in the first direction (i.e. the downstream direction in this embodiment). Also, different DC potentials are applied to different electrodes along the second IMS device so as to form a static electric field that urged ions in the second direction (i.e. the upstream direction in this embodiment). An example of the voltage profile along the second IMS device is shown below the second IMS device. The resulting electric field magnitude would start at zero at the upstream end of the IMS device, rise linearly and then remain constant over a length proximate the downstream end of the IMS device. This is the same as that shown below the first IMS device, although it may be different. The ions are therefore accumulated in the second IMS device in a manner such that they are axially confined at different axial location depending on their mobility.

The second IMS device is then operated in an elution mode in which the magnitude of the DC electric field and/or a parameter the travelling DC potentials is varied with time so as to cause ions to elute from the downstream end of the second IMS device in order of mobility. After the ions of interest, or all of the ions, have eluted from the second IMS device, the second IMS device may be switched back to the ion accumulation mode and the first IMS device may be switched back to the ion ejection mode so as to fill the second IMS device with ions again. The above described cycle may be repeated as many times as desired, with the first IMS device accumulating ions whilst the second IMS device elutes ions according to mobility. This provides the instrument with a relatively high duty cycle, since ions are not lost whilst the second device is being operated to elute ions according to mobility.

It will be appreciated that each of the IMS devices 11a, 11b may have the various features described elsewhere herein. For example, in order to provide the IMS devices with a relatively high space-charge capacity, both the of the IMS devices may have ion guides that define ion guiding regions having a cross-sectional shape that is elongated in one dimension (orthogonal to the longitudinal axis). For instance, the electrodes that define the ion guides of the IMS devices may have substantially rectangular or oval apertures. An ion guiding device 12 may be provided downstream of the second IMS device for changing the cross-sectional shape and/or area of the ion cloud that elutes from the second IMS device such that it matches the cross-sectional shape and/or area able to be received by an ion-optical component downstream of the ion guiding device.

As described herein, the IMS device may use travelling DC potentials to urge ions in the downstream direction and an electric field to urge ions in the upstream direction (and optionally substantially no gas flow). It has conventionally been difficult to empty the IMS device in the elution mode before it is required to be filled with ions again in the accumulation mode. The time available to do this is restricted, if degradation of the duty cycle is to be avoided. However, embodiments are able to select the speed and/or amplitude of the travelling DC potentials to achieve emptying of the IMS device on the desired timescale. Additionally, or alternatively, the direction of the static DC field may be reversed when switching from the accumulation mode to the elution mode, so as to assist in urging ions in the downstream direction.

It is contemplated that at least some of the ions may be fragmented to produce fragment ions, activated so as to produce product ions of different conformation (substantially without fragmentation), or reacted with other ions or neutrals, between the first and second IMS devices 11a, 11b, or within the first and/or second IMS device.

The spectrometer may select ions having a restricted range of mobilities for fragmentation, activation or reaction. This may be achieved, for example, by only transmitting ions from the first IMS device to a fragmentation, activation or reaction region during a portion of the elution time from the first IMS device. In order to achieve this ions may be attenuated between the first and second IMS devices, as described further below. The fragment or product ions may then be confined within the second IMS device and caused to elute according to mobility, as discussed above. Alternatively, rather than the fragment or product ions being transmitted into the second IMS device, the fragment or product ions may be transmitted back upstream into the first IMS device or through the first IMS device and into a trapping region arranged upstream of the first IMS device. These fragment or product ions may then be separated and mobility analysed in the first and second IMS devices, as described above. This cycle of selecting mobilities, fragmenting/activating/reacting the ion and then analysing the resulting fragment or production ions using the second IMS device (and also optionally the first IMS device) may be repeated, where a different range of mobilities is selected for each cycle.

Embodiments are also contemplated in which a first IMS device accumulates and separates ions in an accumulation mode, and then elutes ions downstream towards a second IMS device. The spectrometer may select some of these ions, having a restricted range of mobilities, for fragmentation, activation or reaction. These selected ions may then be transmitted downstream towards a second IMS device. These ions may be fragmented, activated or reacted between the first and second IMS devices, or within the second IMS device, so as to produce fragment or product ions. The fragment or product ions may then be separated in the second IMS device and eluted. The spectrometer may select some of these ions, having a restricted range of mobilities, for further fragmentation, activation or reaction. For example, a selected range of mobilities that elute from the second IMS device may be transmitted back into the second IMS device (or back to the region between the first and second IMS devices) and fragmented, activated or reacted so as to produce second generation fragment or product ions. This cycle of selecting ions and fragmenting, activating or reacting them may be repeated as many times as desired. Whilst the cycle is repeated, ions may be prevented from passing downstream from the first IMS device. In other words, after the initial step of eluting ions from the first IMS device, the first IMS device may operate in an ion accumulation mode.

Although embodiments have been described in which all of the ions accumulated in the first IMS device are ejected into the second IMS device at substantially the same time, it is contemplated that ion filtering may be performed between the first and second IMS devices such that only a subset of the mobilities accumulated in the first IMS device may be transferred to the second IMS device. For example, the first IMS device may be operated in an elution mode in which the magnitude of the DC electric field and/or a parameter of the travelling DC potentials is varied with time in order to cause ions to elute from the downstream end according to their mobility. Only a subset of the mobilities that elute may be allowed to enter the upstream end of the second IMS device during its accumulation mode. For example, an ion gate or ion deflector may be arranged between the two IMS devices 11a, 11b and its operation may be synchronised with the elution of ions from the first IMS device such that during a first period of time the ion gate or ion deflector allows only the subset of mobilities to enter the second IMS device, but during different times it blocks or deflects ions having other mobilities such that they do not enter the second IMS device.

The subset of mobilities may then be confined in the second IMS device in the accumulation mode and subsequently eluted from the second IMS device in the elution mode. The DC electric field and/or travelling DC potentials used in the elution mode of the first IMS device may be different to those used in the elution mode of the second IMS device. For example, the DC electric field and/or travelling DC potentials used in the elution mode of the second IMS device may be optimised to enhance the mobility resolution of the subset of mobilities.

Alternatively, it is contemplated that only fragment or product ions of the subset of mobilities may be allowed to enter the second IMS device. In such embodiments, the ions that have eluted from the first IMS device are subjected to the fragmentation or activation described above at a location between the first and second IMS devices. Ions may only be allowed to be onwardly transmitted to the second IMS device during a certain time period that is synchronised with the elution of ions from the first IMS device such that only the fragment or product ions of the subset of mobilities are able to enter the second IMS device. For example, an ion gate or ion deflector may be arranged between the two IMS devices and its operation may be synchronised with the elution of ions from the first IMS device such that during a first period of time the ion gate or ion deflector allows only the subset of mobilities to be transmitted, but during different times it blocks or deflects ions having other mobilities, and then that subset of mobilities may be fragmented or activated. Alternatively, all ions eluting from the first IMS device may be fragmented or activated but the ion gate or ion deflector may only transmit ions during a time period such that only fragment or product ions of the subset of mobilities are transmitted to the second IMS device.

It is contemplated that an ion gate or ion deflector may also be used downstream of the second IMS device such that only a specific mobility range is transmitted downstream of this ion gate.

It is contemplated that an ion gate or ion deflector may be used even in embodiments that employ only a single IMS device. For example, the ion gate or ion deflector may be arranged downstream of such an IMS device and may be activated and deactivated as ions elute from the IMS device according to their mobility, such that only ions have a certain range of mobilities are onwardly transmitted whilst other mobilities are blocked or deflected such that they are not onwardly transmitted. The onwardly transmitted ions may be mass analysed or may be activated or dissociated and the resulting product or fragment ions may be mass analysed.

The combination of two IMS devices in series may be used to mitigate degradation of performance in mobility separation due to excessive space-charge effects or by exceeding the dynamic range of the ion detection system associated with the IMS devices. An attenuation device may be provided between the first and second IMS devices. Ions may be caused to elute from the first IMS device according to mobility and at least some of the mobilities may be attenuated before being transmitted into the second IMS device. For example, mobilities of interest (e.g. a preselected restricted range of mobilities) that elute from the first IMS device may be attenuated by a relatively low amount, such as not being attenuated, whereas other mobilities eluting from the first device may be partially attenuated by a higher amount, or even fully attenuated. For example, ions may be attenuated between the two IMS devices according to the techniques disclosed in US 2017/0212081, which is incorporated herein by reference.

In embodiments where two or more IMS devices are arranged in series, the devices may reside within the same vacuum chamber of the spectrometer such that the pressure and composition of the background gas within them are substantially the same, or they may be arranged within separate vacuum chambers that may have separate pumping arrangements and which may be separated by a differential pumping aperture. This allows the composition, pressure, and flow characteristics of the background gas to be selected substantially independently for each IMS device.

Although embodiments have been described in which the ions are attenuated between two IMS devices, in order to fill the downstream IMS device with a selected range of mobilities, it is alternatively contemplated that an upstream IMS device may be operated so as to scan out a narrow range of mobilities of interest to a downstream IMS device. For example, mobilities above a low mobility threshold may be scanned out of the upstream IMS device. In order to remove the remaining ions from the first IMS device, so as to ensure that the charge from these ions does not accumulate during subsequent cycles, the first IMS device needs to be purged between fill cycles. This can be achieved by travelling high amplitude DC potentials along the first IMS device (in the first or second direction) and/or by reducing or removing the RF voltage that radially confines ions in the first IMS device.

Although embodiments have been described in which two IMS devices are provided in series, it is alternatively (or additionally) contemplated that two of the IMS device may be provided in parallel, e.g. as shown in FIG. 5. The IMS devices may be operated as described in co-pending application GB 2207395.1, the contents of which are incorporated by reference.

FIG. 5 shows an embodiment having two of the IMS devices 11a, 11b in parallel, each of which is arranged to receive ions from a first ion guide 12 at its upstream end, separate the ions according to mobility and cause ions to be eluted from its downstream end into a second ion guide 13. Each IMS device may be the type described herein above, i.e. that separates ions by mobility using a DC electric field and travelling DC potentials. However, it is alternatively contemplated that the different IMS devices may use different techniques to separate the ions by mobility. For example, one IMS device may separate ions by mobility by using a travelling DC potentials to urge the ions in a first direction and a DC electric field to urge the ions in the second directions, whereas the other IMS device may separate the ions according to mobility by using a gas flow to urge the ions in one direction and a DC electric field or travelling DC potentials to urge the ions in the opposing direction.

Although only two IMS devices are depicted in FIG. 5, it will be appreciated that one or more further IMS device may be provided in parallel with the depicted IMS devices.

Ions may be guided towards the multiple IMS devices as a single ion beam. The single ion beam may then be split into multiple ion beams so that ions simultaneously pass into the upstream ends of the multiple IMS devices whilst they are all simultaneously operating in an ion accumulation mode that traps the ions within a trapping region. Alternatively, and more preferably, the single ion beam may be deflected such that all of the ions in the single ion beam pass into only a single one of the IMS devices at any given time, whilst that IMS device is operating in an ion accumulation mode so as to trap the ions within a trapping region.

Accordingly, ions may be received into an entrance end of the first IMS device during an ion accumulation mode of the first device. The ions are axially confined within the first IMS device by the opposing forces on them, as discussed elsewhere herein. For example, transient DC potentials may be successively applied to successive electrodes arranged along the first IMS device such that DC travelling potentials repeatedly travel in the first direction, which may be the downstream direction. Also, different DC potentials are applied to different electrodes along the first IMS device so as to form a static electric field that urged ions in the second direction, which may be the upstream direction. The ions are therefore confined in the first IMS device in a manner such that they are axially confined at different axial locations depending on their mobility.

The first IMS device may then be switched to an ion elution mode in which ions are caused to exit the downstream end of the first IMS device and pass into the upstream end of the second ion guide. The ions may be caused to elute from the first IMS device in order of increasing or decreasing mobility, as described above. Ions may be prevented from entering the upstream end of the first IMS device during this elution mode, e.g. by providing an electric potential barrier at the entrance end of the first IMS device.

When the first IMS device is switched from the ion accumulation mode to the elution mode, the spectrometer may be automatically switched such that ions pass from the first ion guide into the second IMS device. At this time the second IMS device is operated in an ion accumulation mode. As such, the ions are axially confined within the second IMS device by the opposing forces on them, as discussed elsewhere herein. For example, transient DC potentials may be successively applied to successive electrodes arranged along the second IMS device such that DC travelling potentials repeatedly travel in the first direction, which may be the downstream direction. Also, different DC potentials are applied to different electrodes along the second IMS device so as to form a static electric field that urged ions in the second direction, which may be the upstream direction. The ions are therefore confined in the second IMS device in a manner such that they are axially confined at different axial locations depending on their mobility.

The second IMS device may then be switched to an ion elution mode in which ions are caused to exit the downstream end of the second IMS device and pass into the upstream end of the second ion guide. The ions may be caused to elute from the second IMS device in order of increasing or decreasing mobility, as described above. Ions may be prevented from entering the upstream end of the second IMS device during this elution mode, e.g. by providing an electric potential barrier at the entrance end of the second IMS device.

When the second IMS device is switched from the ion accumulation mode to the elution mode, the spectrometer may be automatically switched back such that ions pass from the first ion guide into the first IMS device. At this time the first IMS device has switched back to operating in the ion accumulation mode. The above described cycle may be repeated as many times as desired, with the first IMS device accumulating ions in the ion accumulation mode whilst the second IMS device elutes ions in the elution mode, or vice versa. This provides the instrument with a relatively high duty cycle, since ions may not be lost whilst either IMS device is operating in an elution mode.

It will be appreciated that one or both of the IMS devices may have the various features described elsewhere herein. For example, in order to provide the IMS devices with a relatively high space-charge capacity, both the of the IMS devices may have ion guides that define ion guiding regions having a cross-sectional shape that is elongated in one dimension (orthogonal to the longitudinal axis). For instance, the electrodes that define the ion guides of the IMS devices may have substantially rectangular or oval apertures.

Alternative embodiments are contemplated in which ions are caused to elute from the exits of the multiple IMS devices simultaneously and these multiple ion streams from the multiple IMS devices may be combined to form a single ion beam. In such embodiments, the multiple IMS devices are preferably synchronised such that at any given time the ions exiting all of the IMS devices have the same mobility. This enables the ions to remain separated according to mobility in the combined ion beam. This may be preferred in the embodiments in which the single ion beam received by the IMS devices is split such that ions enter the multiple IMS devices at the same time.

Although the embodiment depicted in FIG. 5 shows both of the first and second IMS devices arranged such that their central axes are radially displaced from the central axes of the first and second ion guides, it is contemplated that the first IMS device may have its central axis arranged coaxially with the central axes of the first and second ion guides. As such, when the first IMS device is being operated in the ion accumulation mode, ions are able to directed from the first ion guide into the first IMS device, and from the first IMS into the second ion guide, without having to be deflected. Ions are still required to be deflected into the second IMS device when the second IMS device is operating in the ion accumulation mode.

Embodiments have been described in which IMS devices are arranged either in parallel or in series. However, it is contemplated that IMS devices may be arranged both in parallel and in series. For example, a first set of two IMS devices arranged in series may be provided in parallel with a second set of two IMS devices that are arranged in series. In such an embodiment the whole of the elution time of the downstream IMS device in one of the sets can be used to transfer ions from the upstream IMS device to the downstream IMS device in the other set. This allows ions to be processed in one of the sets (such as by gating, fragmenting or activating the ions between the IMS devices) without losing duty cycle or having to ballistically move ions from one IMS device to another.

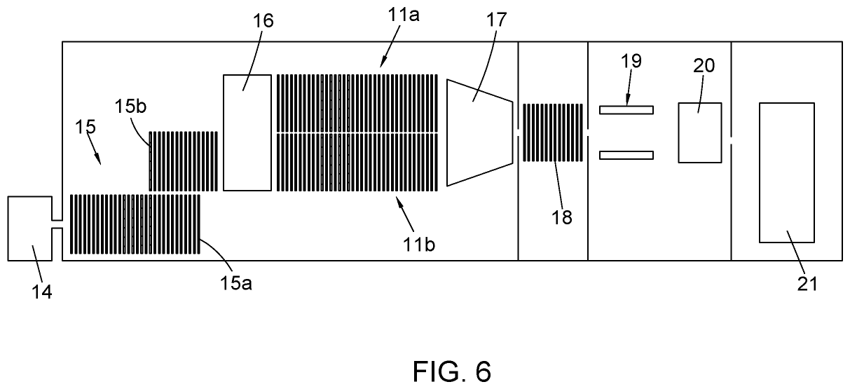

FIG. 6 shows a schematic of an embodiment of a spectrometer that comprises two IMS devices 11a, 11b arranged in parallel. The spectrometer comprises an ion source 14, a first ion guide 15, a deflector 16, two parallel IMS devices 11a, 11b, an ion funnel 17, a second ion guide 18, a quadrupole mass filter 19, a fragmentation, activation or reaction cell 20 and a mass analyser 21 such as a TOF mass analyser. The first ion guide, deflector, IMS devices and ion funnel may be arranged in a first vacuum chamber that is at a relatively high pressure, such as ≥1 mbar. For example, the spectrometer may maintain the first vacuum chamber at a pressure between 2-5 mbar. The second ion guide may be arranged in a second vacuum chamber that is at a lower pressure than the first vacuum chamber, e.g. between 10-3 and 10-1 mbar, such as around 10-2 mbar. The quadrupole mass filter and fragmentation, activation or reaction cell may be arranged in a third vacuum chamber that is at a lower pressure than the second vacuum chamber, e.g. between 10-4 and 10-3 mbar. The mass analyser may be arranged in a fourth vacuum chamber that is at a lower pressure than the third vacuum chamber, e.g. around 10-5 mbar.

In use, ions are supplied from the ion source into the first ion guide 15. The first ion guide may (or may not) be a conjoined ion guide, such as a Stepwave ion guide, that has a first portion 15a that receives the ions at an upstream end and guides them downstream along its central axis before transferring the ions in the radial direction into a second portion 15b of the ion guide. The second portion of the ion guide then guides the ions along its central axis, which is parallel to and radially displaced from the central axis of the first portion, such that the ions are guided to the deflector. Different DC voltages may be applied to the electrodes of the first and second portions of the ion guide so as to cause the radial transfer of the ions between the two portions. RF voltages may be applied to the electrodes of the first and second portions in the known manner in order to radially confine the ions therein. DC potentials may be travelled along the first and/or second portions of the ion guide in order to urge ions therethrough, or a potential difference may be applied across the ion guide in order to urge ions therethrough.

The central axis of the second portion of the ion guide may be coaxial with the central axis of one of the IMS devices. The central axis of the first portion of the ion guide is preferably not coaxial with a longitudinal path through the deflector and/or either of the IMS devices. As such, the deflector may be set to a first mode (e.g. an inactive mode) in which the ions from the first ion guide are not deflected by the deflector and pass into the first IMS device. The deflector may alternatively be controlled to operate in a second mode (e.g. an active mode) in which the ions from the first ion guide are deflected by the deflector such that they pass into the second IMS device. This enables the spectrometer to fill the IMS devices with ions and operate in any of the manners described above, e.g. with respect to FIG. 5. It will be appreciated that the deflector may comprise one or more electrodes and that one or more voltages may be applied to the electrodes in order to cause the deflector to operate in the modes described. It will also be appreciated that the central axis of the exit of the first ion guide need not be aligned with one of the IMS devices and that the deflector may be operated such that in a first mode it deflects ions from the ion guide into the first IMS device and in a second mode it deflects ions from the ion guide into the second IMS device.

Each of the IMS devices may have any of the features described elsewhere herein, e.g. in relation to FIGS. 1-5.

The ions that elute from the IMS devices may be received by the ion funnel that may funnel the ions down and transmit them through a differential pumping aperture into the second vacuum chamber. The ions are then guided by the second ion guide through the second vacuum chamber and through a differential pumping aperture into the third vacuum chamber. It will be appreciated that the second vacuum chamber is provided primarily to ease the vacuum pumping required to achieve the desired pressures in the third and fourth vacuum chambers. However, the second vacuum chamber, and optionally also the second ion guide, may be omitted if desired.

The ions may then be transmitted into the quadrupole mass filter, which may mass filter the ions such that only ions having a restricted range of mass to charge ratios are transmitted to the fragmentation, activation or reaction cell, whereas other ions are filtered out by the mass filter and not transmitted. It is contemplated that a mass filter other than a quadrupole mass filter may be employed. Alternatively, or additionally, an ion gate or other form of ion attenuator may be used to selectively block or partially attenuate ions that have eluted from the IMS devices. Such an ion gate or ion attenuator may be synchronised with the elution cycle of ions from either of the IMS devices such that only ions having preselected mobilities are transmitted or blocked/attenuated by the ion gate/attenuator.

The ions that are transmitted by the mass filter or ion gate/attenuator may then be mass analysed in the mass analyser. Alternatively, these ions may first pass into the fragmentation, activation or reaction cell, in which the ions may be fragmented so as to form fragment ions, activated so as to change conformation (substantially without fragmentation), or reacted with other ions or molecules so as to form product ions. The resulting ions may then pass into the mass analyser and be mass analysed.

Various embodiments have been described herein which comprise multiple IMS devices. It is contemplated that in each of these embodiments the different IMS devices may be filled gases at different pressures and/or having different chemical compositions. For example, one of the IMS devices may be filled with one or more type of gas that is not in another of the IMS devices. Alternatively, each of the different IMS devices may include a mixture of the same gases, but where the concentration of a given one or more of the gases is different in the different IMS devices.

Alternatively or additionally, one of the IMS devices may have a dopant as described herein above, whereas another of the IMS devices may not or may have a different dopant.

Each of the IMS devices described herein may be operated in a manner that is synchronised with an upstream separator, such as a liquid or gas chromatography device. For example, a sample to be analysed may be separated by such a chromatography device prior to being ionised and the resulting ions (or ions derived therefrom) may then be supplied to one or more of the IMS devices described herein. The IMS device may repeatedly perform a cycle comprising the accumulation mode and elution mode described herein, as the sample elutes from the chromatography device. However, different accumulation modes and/or elution modes may be operated differently at different retention times of the chromatography device. For example, the DC electric field and opposing DC travelling potentials may be operated such that ions having different mobility ranges are trapped within the IMS device in accumulation modes that occur at different retention times of the chromatography device.

Alternatively, or additionally, the DC electric field and opposing DC travelling potentials may be operated such that in elution modes that occur at different retention times of the chromatography device, ions are caused to elute from the IMS device at different rates. For example, in an elution mode that occurs at a first retention time the ions may be caused to elute from the IMS device over a first duration, whereas at a second retention time the ions may be caused to elute from the IMS device over a second, different duration. For instance, this enables analytes of interest that are expected to elute from the chromatography device at the second retention time to be eluted from the IMS device over a relatively long duration, e.g. at a slower rate and higher mobility resolution.

The IMS device may be synchronised with the upstream separator such that the operation of the IMS device is varied as a function of the retention time of the upstream separator in a predetermined manner. Alternatively, the spectrometer may first operate in a survey scan mode in which the sample is introduced into the separator, separated in the separator, ionised and the ion mobility and/or mass analysed of the resulting ions determined as a function of retention time in the separator. Ions having a restricted range of mobilities and/or mass to charge ratios may then be selected as being target ions of interest and a data dependent experiment may then be performed in which the sample is introduced into the separator, separated in the separator, and ionised. In this data dependent experiment the IMS device may be synchronised with the separation cycle of the upstream separator such that when the target ions of interest are received in the IMS device, the IMS device is controlled to operate in a predetermined manner. For example, when the IMS device may be controlled to operate in an accumulation mode and/or elution mode that is selected, and optionally optimised, for the target ions of interest. For instance, at this retention time the IMS device may operate in an accumulation mode that substantially only traps ions having mobilities corresponding to the target ions of interest; and/or the IMS device may be operated in an elution mode that elutes ions over a longer duration than in elution modes that occur at other retention times at which the target ions of interest are not expected to be in the IMS device.

In the above, or alternative, embodiments that have an upstream separator, such as a liquid or gas chromatography device, the range of ion mobilities of interest that arrive at the IMS device at a particular chromatographic retention time may be known or determined. The operational parameters of the travelling DC potentials applied to the IMS device may then be selected, e.g. altered, at this retention time so as to optimise the mobility separation of the ions of interest and/or to minimize distortions due to space-charge effects at this specific chromatographic retention time. The required operational parameters may be determined from a survey scan performed during the same analytical run using a data dependent method, or may be determined during a previous analytical run and stored as a pre-determined list that is linked to the retention time.

Additionally, or alternatively, the operational parameters of the IMS device used in the elution mode may be selected to optimise the performance of a downstream ion-optical device that is operated in synchronism with the elution mode of the IMS device, such as a quadrupole mass filter or time of flight mass spectrometer.

Ions exit the IMS devices described herein in order of increasing or decreasing ion mobility. These ions may then pass downstream through an ion-optical device, such as a gas-filled ion guide or other gas-filled device. The ions may be urged through the downstream ion-optical device in a manner that preserves the ion mobility separation that has been imparted to the ions by the IMS device. For example, the ions may be urged through the ion-optical device using a DC field, a pseudo-potential field (due to RF voltages being applied to electrodes), or by travelling DC potentials along the ion-optical device. In embodiments that travel DC potentials along the ion-optical device, the DC potentials may be provided with relatively high amplitudes such that a packet of the ions is trapped between each pair of adjacent DC potentials that are being travelled along the device, and hence the packet of ions is urged through the ion-optical device. In other words, as ions of different mobilities elute from the IMS device they enter the ion-optical device and become trapped between different, respective pairs of DC potentials that are travelled along the ion-optical device from the upstream end to the downstream end.

Alternatively, the ion mobility separation of at least some of the ions eluting from the IMS device may be deliberately lost in an ion-optical device downstream of the IMS device. For example, the ions may elute from the IMS device into a gas-filled ion-optical device, such as an ion guide, and be allowed to diffuse such that ions of different mobilities mix. Accordingly, ions elute from the IMS device according to mobility but may then mix so as to form a semi-continuous ion beam that includes ions of different mobilities at any given part of the ion beam. Allowing the ions to re-mix in this manner may improve the dynamic range of a downstream mass analyser, such as an orthogonal time of flight mass analyser.

The mobility separation of the ions may be deliberately lost in embodiments where the mobility separation is no longer required. For instance, an ion gate or other filter may be provided downstream of the IMS device and operated such that only ions having one or more ranges of mobility are transmitted by the ion gate or filter, with the other ions not being transmitted. Once the desired ions have been selected for transmission there may be no need to maintain the ion mobility separation and so the transmitted ions of different mobility may be allowed to re-mix. According to another example, it may be desired to transmit or filter out ions of only a certain charge state, e.g. it may be desired to filter out singly charged ions (as are often background ions of low interest). In such an embodiment a mass filter may be synchronised with the IMS device such that only ions of a desired charge state are transmitted by the combination of both the mass filter and IMS device. Ions of different mobility may then be allowed to remix downstream of both the mass filter and IMS device.

A particularly advantageous embodiment of the invention is to improve the duty cycle of a quadrupole mass filter. Such an embodiment comprises an IMS device as described herein followed by a downstream quadrupole mass filter. The mass filter may be followed by a downstream fragmentation or reaction device for fragmenting or reacting the ions that are transmitted by the mass filter so as to form fragment or product ions. The fragmentation or reaction device may be followed by a mass analyser, such as a TOF mass analyser.

This embodiment may be operated in a data dependent acquisition (DDA) mode of operation in which a survey scan is first acquired. In this mode the quadrupole mass filter may be operated in a non-mass resolving mode (i.e. as an ion guide) or in a wide m/z bandpass mode, and the fragmentation or reaction device may be inactive. The ions are separated by the IMS device and mass analysed by the mass analyser such that the survey scan provides two dimensional information that maps the elution time of each ion from the IMS device (i.e. the ion's mobility) with the mass to charge ratio detected for the ion, e.g. at a specific chromatographic retention time of an LC device arranged upstream of the IMS device. This map may then be used to select a number of temporally separated ion species as ions of interest.

In a subsequent experiment mode of operation on the same sample, the operation of the mass filter is synchronised with the IMS device such that all of the species of interest, and substantially only the species of interest, are transmitted by the mass filter during a single mobility separation cycle. In order to achieve this, the mass filter is controlled based on the two dimensional information obtained during the survey scan. For example, at a time corresponding to the elution time from the IMS device of one of the species of interest (or a related time if the IMS conditions have changed between the survey scan and experiment modes), the mass filter may be controlled to transmit ions having a mass to charge ratio corresponding to the mass to charge ratio of that species of interest. Each of the selected ions species may then be fragmented or reacted in the downstream fragmentation or reaction device and the resulting ions may be mass analysed by the mass analyser. This method increases the duty cycle of the quadrupole mass filter and adds specificity when analysing a plurality of different m/z species with the same or similar chromatographic retention time. The method may be operated as described in U.S. Pat. No. 9,576,777, which is incorporated herein by reference.

It is alternatively contemplated that the method may be operated in a targeted mode of operation in which the chromatographic elution time, IMS device elution time and the m/z value for a list of target ion species may be recorded using standards in a previous experiment or method development step, rather than performing a survey scan and experimental mode on the same sample. An experimental mode corresponding to that described above may then be performed in which the mass filter is operated so as to transmit the target ion species.

It is contemplated that the IMS devices described herein may be operated such that they separate ions primarily by mass to charge ratio, rather than mobility (as described elsewhere herein). In such an embodiment the calibration relationship between elution time and mass to charge ratio can be predetermined and used to synchronize the mass filter operation with the separator device. Only the mass to charge ratio of the target ion is required to be determined form a survey scan, as the time of elution can be calculated from calibration of the device.

Various data independent acquisition modes are contemplated in which the operation of a mass filter, such as a quadrupole mass filter, is synchronised with the elution of ions from the IMS device. For instance, the mass filter can be scanned or stepped over a predetermined m/z range with a predetermined m/z transmission window relationship, in a manner that is synchronised with the elution of ions from the IMS device. This may be used to improve duty cycle.

Embodiments are contemplated in which the elution of ions from the IMS device is synchronised with the operation of a mass filter such that the mass filter only transmits ions having a particular charge state or states. Alternatively, multiple different scans may be performed sequentially such that ions having multiple charge states are transmitted.

In an embodiment in which the IMS device is controlled to separate the ions primarily by m/z, rather than mobility, the operation of a scanned mass filter may be synchronised with the elution of ions from the separator so as to improve the duty cycle of the mass filter. This is advantageous, for example, in applications where separation based on mobility may not be important but high duty cycle MS/MS for all species is desired. These embodiments may also be useful in metabolomics or pesticide screening etc., where most of the ions are singly charged, or in instruments having APCI or EI ion sources, where fewer multiply charged ions are generated.

In embodiments in which the IMS device separates ions primarily by mobility, the elution of ions from the IMS device may be synchronised with the operation of a mass filter that is operating in a band-pass or low mass cut off mode so as to charge strip the mass spectral data with a relatively high duty cycle. The mobility separation may not be maintained downstream of the mass filter, or in the recorded mass spectral data.

In the embodiments described herein in which the mass filter is operated in synchronism with the IMS device (or m/z separator), the mass filter may be scanned substantially continuously as the ions elute from the separator for the whole or majority of the elution mode. Alternatively, the mass filter may be scanned substantially continuously during part of the elution mode, stepped discontinuously, and then scanned substantially continuously again during another part of the elution mode. For example, in the embodiments in which a survey scan is performed, the mass filter may be scanned substantially continuously as the ions of interest are expected to elute and stepped discontinuously over ranges that are not of interest.

IMS devices have been described herein as being synchronised with a downstream mass filter, but it is alternatively, or additionally, contemplated that the IMS device may be synchronised with the operation of a downstream TOF mass analyser. In such embodiments, the time at which the IMS device is caused to elute ions may be synchronised with the timings at which the pusher of the TOF mass analyser is activated such that ions are pulsed ions into its time of flight region of the TOF mass analyser. The timings at which the pusher is activated so as to pulse ions may be synchronised with the elution of ions from the IMS device such that one or more ion mobility ranges are mass analysed by the TOF mass analyser with relatively high duty cycle.

It is alternatively contemplated that the IMS device is controlled to separate the ions primarily by m/z, rather than mobility. In such an embodiment the timings at which the pusher is activated so as to pulse ions may be synchronised with the elution of ions from the separator device such that one or more mass ranges are mass analysed by the TOF mass analyser with relatively high duty cycle.

The IMS devices described herein may be used as an upstream IMS device that is arranged upstream of a further IMS device, e.g. so as to restrict the range of ion mobilities entering the further IMS device. For instance, the upstream IMS device will have a high mobility cut-off for set by the parameters of the DC travelling potentials and the maximum static electric field used during the accumulation mode. Ions having a mobility above this cut-off value (e.g. below a certain m/z) will exit the IMS device and be lost. The low mobility cut-off of the IMS device depends on the static electric field at the start of the trap during the accumulation mode. Ions may be delivered to the IMS device from an upstream ion guide. A short region providing no ion confinement may be arranged between the upstream ion guide and the IMS device. Ions may be urged from the upstream ion guide to enter the IMS device using a DC potential drop between the two devices. Ions having a mobility above a certain value will not enter the IMS device and will be lost, whereas ions having lower mobilities will enter the IMS device. In this way the IMS device will only contain a set mobility range. In embodiments in which it is desired to operate the IMS device primarily as a mass separator, it will be appreciated that the separator device and upstream components may be operated such that a selected range of mass to charge ratios are confined in the separator device. In order to be able to fully adjust the mobility or mass range confined each electrode in the separator device region may be controlled by an individual electronic supply such that the field shape can be changed.

The (upstream) IMS device may effectively be used as an ion trap and source of ions for the further IMS device. The further IMS device may be a different type of IMS device to the upstream IMS device. For example, the further IMS device may separate ions using only a DC electric field in the presence of a background gas, or using only travelling DC potentials in the presence of a background gas. The further IMS device may be configured to separate ions by mobility along a linear path, a closed-loop path, a serpentine path or any other tortuous path. The further IMS device may be a drift tube IMS device that is operated so as to provide collisional cross-section measurements of the ions.

Ions eluting from the upstream IMS device will enter the further IMS device and continue to be separated therein by mobility. The mobility resolution of the further IMS device will be improved by this technique, as well as the space-charge capacity of the up-stream trap.

A separate ion trap may be provided upstream of the upstream IMS device in order accumulate ions when the upstream IMS device is operating in the elution mode, and to transmit ions into the upstream IMS device when the upstream IMS device is operating in the accumulation mode. This allows the spectrometer to operate with up to 100% duty cycle. Alternatively, rather than providing said separate ion trap, two upstream IMS devices may be provided in parallel as described above, in order to operate the spectrometer with up to 100% duty cycle. These techniques also enable the upstream ion device to operate with a relatively long elution time mode, without adversely impacting the duty cycle or the performance of the spectrometer. This allows ions to elute from the upstream IMS device over a relatively long timescale, which allows more time for a downstream ion-optical device to change operational state in a mobility dependent way. For example, if a quadrupole mass filter is provided downstream this allows more time to change the mass transmission window of the quadrupole mass filter within the elution period of the upstream IMS device.

Alternatively, or additionally, to using an IMS device of the type described herein upstream of a further IMS device, an IMS device of the type described herein may be used downstream of said further IMS device. In such embodiments the further IMS device may be operated so as to restrict the range of mobilities entering the IMS device of the type described herein.

Embodiments are contemplated in which the IMS device described herein is arranged so as to provide ions to a downstream mass selective ion trap, such as a quadrupole linear ion trap or even a 3D ion trap for example. The ion trap may be operated in synchronism with the IMS device such that only ions of selected mobility fill the ion trap. This would help space-charge issues of the mass selective ion trap. Alternatively, or additionally, a mass selective ion trap could be provided upstream of the IMS device so as to limit the range of mass to charge ratios entering the IMS device.

Embodiments are contemplated in which the IMS device described herein is used in an arrangement that performs an HDMSe mode of operation. Such an instrument comprises a chromatography device upstream of the IMS device, and a fragmentation or reaction device and mass analyser downstream of the IMS device. The instrument may operate in a precursor ion analysis mode in which analyte elutes from the chromatography device and is ionised, and the resulting precursor ions are then separated by mobility in the IMS device. Precursor ions elute from the IMS device and pass through the fragmentation or reaction device, which is inactive in this mode, and are mass analysed. The mass to charge ratio detected for a precursor ion species may then be associated with its retention time in the chromatography device and its elution time from the IMS device.

The instrument may also operate in a fragment/product ion analysis mode that is substantially the same as the mode described above, except that the fragmentation or reaction device is activated such that the precursor ions are fragmented or reacted therein so as to form fragment or product ions, which are then mass analysed. As the time at which any given fragment or product ion species is mass analysed is related to the retention time in the chromatography device and the elution time from the IMS device of its precursor ion species, the fragment or product ion species is able to be associated with its precursor ion species. The instrument may be repeatedly alternated between the precursor ion analysis mode and the fragment/product ion analysis mode in a single experimental run, i.e. while sample elutes from the chromatography device.

These HDMSe embodiments may alternatively be operated with the IMS device operating primarily as a m/z, rather than a mobility separator.

The IMS device described herein may be used in conjunction with a differential mobility separator, a FAIMS device or a differential mobility analyser. Such devices may be provided upstream of the IMS device so as to mobility filter the ions passing to the IMS device and therefore restrict the mobility range passing into the IMS device. Alternatively, or additionally, such devices may be arranged downstream of the IMS device, e.g. a low pressure FAIMS or differential mobility separator.

Embodiments are contemplated in which the IMS device described herein is arranged at the upstream end of an electrostatic ion trap or an electrostatic ion trap mass analyser such as an Orbitrap or FTICR analyser. Ions of selected mobility may be allowed to pass from the IMS device to the mass analyser.

Although the IMS device has been described herein as being operated in an ion mobility separation mode, embodiments are contemplated in which it is operated in a mass to charge ratio separation mode, i.e. so as to separate ions primarily by mass to charge ratio rather than mobility. The device may switch from the mobility separation mode to the mass to charge ratio separation mode by performing at least one of the following: increasing the speed of the travelling DC potentials; increasing the amplitude of the travelling DC potentials; reducing the pressure of the gas in the device; and changing the gas in the device to have a lower collisional cross-sectional area.

As described above, the IMS device described herein separates ions according to mobility using the force from a DC static electric field and the opposing force due to travelling DC potentials. However, the IMS device may be operated in a further IMS mode in which it need not drive the ions in opposing directions in order to separate them according to mobility. Rather, the ions may only be driven in the downstream direction, through a substantially static background gas, such that the ions separate according to mobility. For example, the ions may only be driven in the downstream direction using a static DC electric field (e.g. by applying a potential difference across the IMS device), or may only be driven in the downstream direction using travelling DC potentials. Accordingly, ions need not be confined axially during the mobility separation of the further IMS mode. As such, the IMS device may separate ions relatively quickly in the further IMS mode, and separate ions more slowly and/or with higher mobility resolution in the other mode.

Embodiments are contemplated in which ions are first separated in one of the IMS devices described herein and caused to elute downstream. At least some of the mobilities that elute may then be passed back into the IMS deice or to an ion trap upstream of it. For example, a subset of the mobilities that were separated may be passed back into the IMS device or an upstream ion trap. These ions may then be separated by mobility in the IMS device for a second time. The operational parameters of the IMS device may be altered between each separation cycle. The above process may be repeated as many times as desired, where each time only a subset of the separated ions is transmitted back into the IMS device to be separated again. Embodiments in which the IMS device uses substantially no gas flow to separate the ions are particularly useful for this technique. For example, the direction of the travelling DC voltages may be reversed so as to travel in the upstream direction in order to load the subset of ions back into the IMS device, or to drive them to the upstream ion trap. The direction of the travelling DC voltages may then be reversed back to the downstream direction when it is desired to separate the subset of ions my mobility.

Although the present invention has been described with reference to various embodiments, it will be understood by those skilled in the art that various changes in form and detail may be made without departing from the scope of the invention as set forth in the accompanying claims.

For example, embodiments have been described in which voltages are applied to electrodes of the ion separation device so that DC potentials travel along the ion separation device and urge ions along it, but there are several ways to provide potentials that travel along the ion separation device so as to urge ions along it. For instance, a periodic or harmonic voltage waveform having an amplitude that oscillates with time may be applied to the electrodes of the ion separation device, where different phases of the voltage waveform are applied to electrodes that are located at different axial locations along the ion separation device so as to cause ions to be urged along the device. The voltage waveform may be any periodic or harmonic wave including, but not limited to, a sine or cosine wave, a square wave, a trapezoidal wave, a triangular wave or a sawtooth wave. The voltage waveform may be a waveform that has a continuously varying amplitude.

For example, a first electrode (or multiple axially adjacent electrodes) may be supplied with a harmonically oscillating voltage waveform with an initial phase shift of 0 degrees. A second electrode (or multiple axially adjacent electrodes) may be supplied with the voltage waveform, but with the initial phase shifted by 90 degrees. A third electrode (or multiple axially adjacent electrodes) may be supplied with the voltage waveform, but with the initial phase shifted by 180 degrees. A fourth electrode (or multiple axially adjacent electrodes) may be supplied with the voltage waveform, but with the initial phase shifted by 270 degrees. This pattern of applying the voltage waveform to electrodes of the ion separation device may then be repeated along the device. The voltage waveform may be applied to the electrodes of the device so as to effectively form a smoothly varying potential that travels along the ion separation device and acts to urge ions axially along the device. The frequency of this four-phase voltage supply and the distance between the electrodes (i.e. pitch of the electrodes) may be selected so as to dictate the velocity of the travelling potential. Such a system is described, for example, in A. W. Colburn et al., Physics Procedia 1 (2008) 51-60, Colburn et al.

It will be appreciated that a waveform having more than four phases, or even three phases, may be applied to respective electrodes so as to urge the ions along the device. It is contemplated that the amplitude and/or frequency of the voltage waveform may be altered with time. Additionally, or alternatively, the phases of the voltage waveform that are applied to the different electrodes may be altered with time, e.g. so that the potential travels along the ion separation device in the opposite direction.

In addition to the phase shifted voltage waveform, axially adjacent electrodes may be supplied with opposite phases of a separate RF waveform for radially confining ions within the device. This enables the radially confining potential and the axial travelling potential to be adjusted independently of each other. The confining RF waveform and the phase shifted travelling potential waveforms may be superimposed. These oscillating waveforms may be capacitively coupled to the electrodes, optionally allowing complex DC potentials to be simultaneously applied to the electrodes, for example, using DC resistive divider circuits between the electrodes in the axial direction.

Although the IMS devices have been described herein as separating and eluting ions according to mobility, it is contemplated that ions may alternatively be separated and eluted according to mass to charge ratio. It is known that in IMS devices in which a DC potential is repeatedly travelled along the device in order to separate ions by mobility, there is a mass to charge ratio dependence in the ion separation, e.g. as described in K. Richardson, D. Langridge, K. Giles, Fundamentals of travelling wave ion mobility revisited: I. Smoothly moving waves, International Journal of Mass Spectrometry, Volume 428, 2018, Pages 71-80. Operational parameters of the separator, such as pressure and/or speed of the travelling DC potentials, may be selected such that it primarily separates ions by mobility, such that it primarily separates ions by mass to charge ratio, or such that it operates in a mode where the ion separation is significantly dependent on both mobility and mass to charge ratio. It is also contemplated that the separator can be operated in only one of these modes, or switched between two or more of these modes by varying one or more of its operational parameters. For example, embodiments are contemplated in which the pressure within the separator is reduced so as to reduce the mobility dependence of the separation and increase the mass to charge ratio dependence of the separation. Such an embodiment may switch from a mode that primarily separates ions by mobility to a mode that primarily separates ions by mass to charge ratio by reducing the pressure in the separator.

A specific embodiment will now be described in order to illustrate how the device described herein may be used primarily as a mobility separator in one mode and/or primarily as a mass to charge ratio separator in another mode. The spectrometer comprises an electrospray ionisation source for generating ions, a separator device for separating the ions by mobility or mass to charge ratio (having a laterally extended ion guiding channel of 5×50 mm), an ion funnel for funnelling the separated ions down, an ion guide for receiving the ions from the ion funnel, and a time of flight mass analyser for mass analysing the ions that are transmitted by the ion guide. The separator device had a 60 mm long accumulation region at its upstream end in order to accumulate ions prior to separation, and a 90 mm long separation region immediately downstream of the accumulation region.

A sample comprising a simple mixture of peptides as shown in the table below was infused into the electrospray ionisation source, which was operated in positive ion mode.

| Peak | Component | Retention Time | Molecular Weight | | |
|---|---|---|---|---|---|
| # | Name | *(minutes) | **(w/mol) | pKa | Peptide Sequence |
| 1 | Allantoin (V0 | 0.76 | 158.0440 | — | — |
| | marker) | | | | |
| 2 | RASG-1 | 4.76 | 1000.4938 | 9.34 | RGDSPASSKP |
| 3 | Angiotensin frag. | 9.59 | 898.4663 | 7.35 | DRVYIHP |
| | 1-7 | | | | |
| 4 | Bradykinin | 12.04 | 1059.5613 | 12.00 | RPPGFSPFR |
| 5 | Angiotensin II. | 13.06 | 1045.5345 | 7.35 | DRVYIHPF |
| 6 | Angiotensin I. | 14.92 | 3295.6775 | 7.51 | DRVYIHPFHL |
| 7 | Renin substrate | 16.82 | 3757.9253 | 7.61 | DRVYIHPFHLIVYS |
| 8 | Enolase T35 | 19.18 | 1871.9604 | 7.34 | WLTGPQLADLYHSLMK |
| 9 | Enolase T37 | 23.55 | 2827.2808 | 3.97 | YPIVSIEDPFAEDDWEAWSHFFK |
| 10 | Melittin | 24.93 | 2845.7381 | 12.06 | GIGAVLKVLTTGLPALISWIKRKRQQ |

The separation device was operated in a first mode in which it contained nitrogen at a pressure of about 2 mbar. The ion accumulation region of the separating device was filled with ions for 0.1 seconds before the ions were ejected into the downstream separation region. A voltage gradient of 1 V/mm was maintained over the separation region so as to urge ions in the upstream direction. DC voltages were repeatedly travelled along the separation region in the downstream direction at a speed of 1008 m/s so as to urge the ions downstream against the force due to the voltage gradient. The amplitude of each DC voltage travelled along the separation region was ramped from 55V to 80V over a 0.1 second period so as to cause ions having different properties to elute from the downstream end of the separation device at different times. The eluting ions were funnelled into the ion guide by the ion funnel, and the ions transmitted by the ion guide were then mass analysed in the time of flight mass analyser.

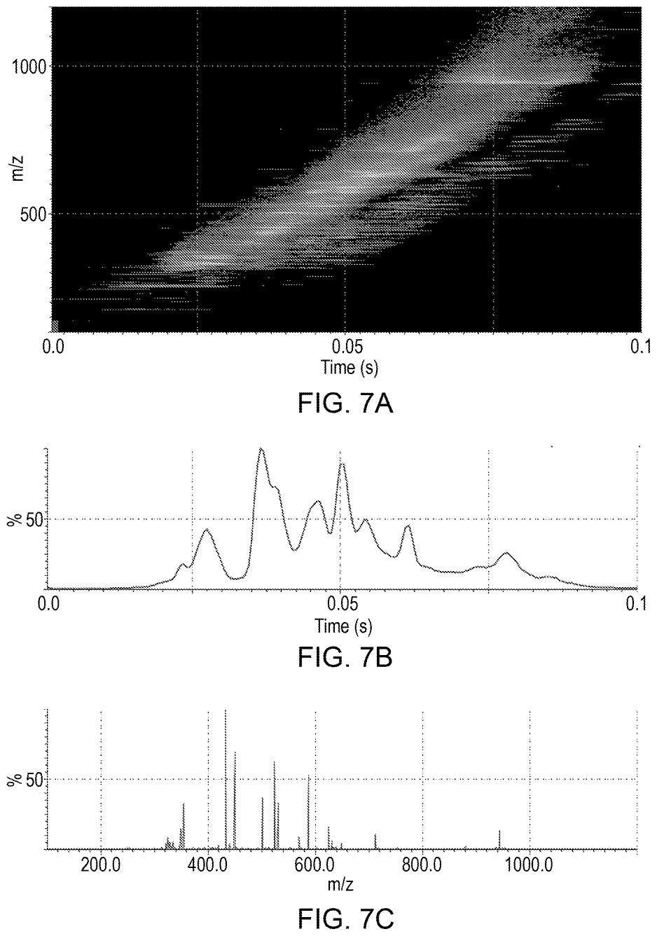

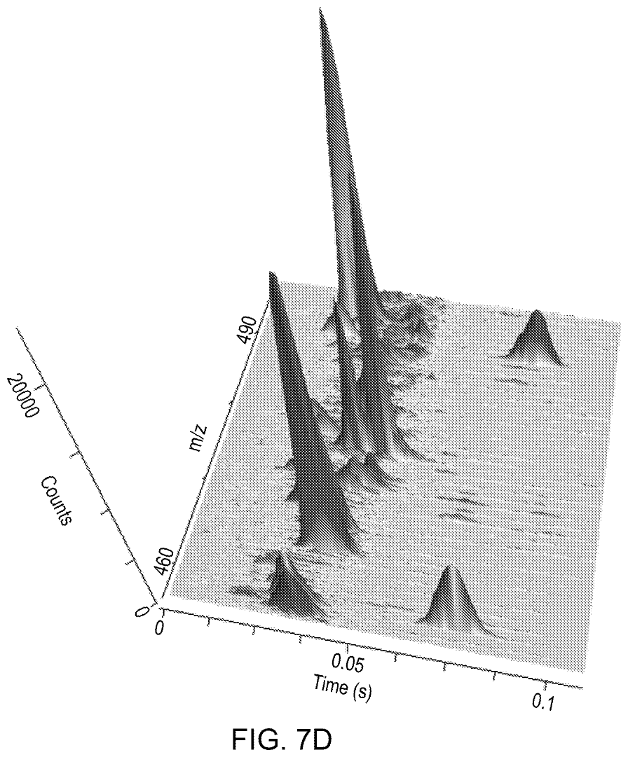

FIG. 7A shows a heat map of the ions that were detected by the time of flight mass analyser during the 0.1 second period that ions were caused to elute from the separation device, where the y-axis represents the mass to charge ratio of the detected ions, the x-axis represents time during the elution cycle, and the intensity of the shading in the heat map represents the intensity of ions that were detected. In this example, 200 mass spectra were obtained by the time of flight mass analyser during the 0.1 second period that ions were caused to elute from the separation device. FIG. 7B is a plot of the same data as in FIG. 7A, except illustrating the total intensity of ions of all mass to charge ratios as a function of time during the 0.1 second period that ions were caused to elute from the separation device. FIG. 7C shows the summed mass spectrum obtained by detecting ions over the entire 0.1 s elution time. FIG. 7D shows a 3D plot of the data from FIG. 7A, for the portion of the data having an elution time from the separation device between 25 ms and 70 ms, and having a mass to charge ratio range from 455-495. The y-axis represents the mass to charge ratio of the detected ions, the x-axis represents time during the 0.1 second period that ions were caused to elute from the separation device, and the z-axis (out of the page) represents the intensity of the ions that were detected. It can be determined from this that the ions are separated in the ion separation device predominantly according to ion mobility. More specifically, this can be determined because ions of a particular charge state tend to follow a trend line that relates mass to charge ratio to mobility.

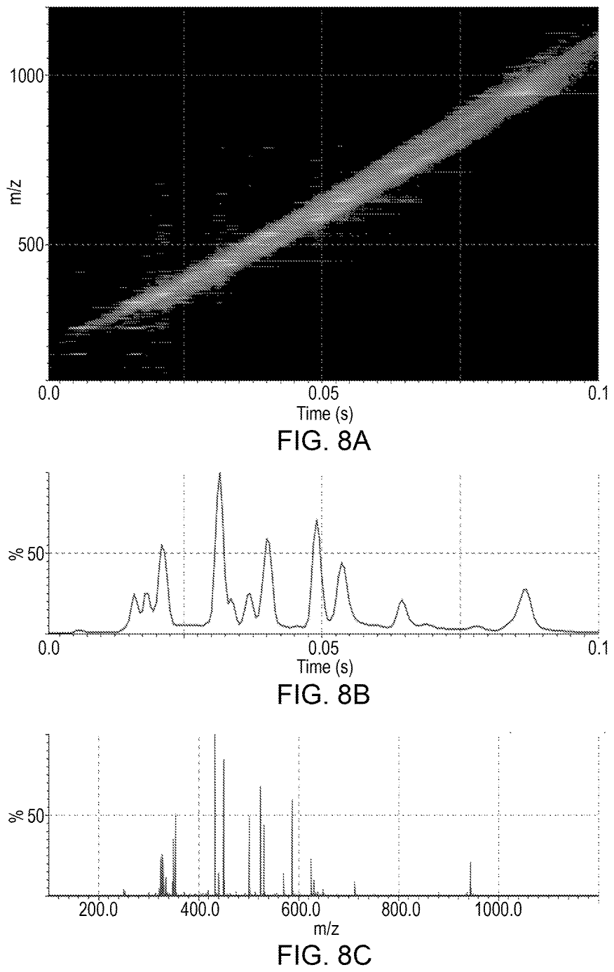

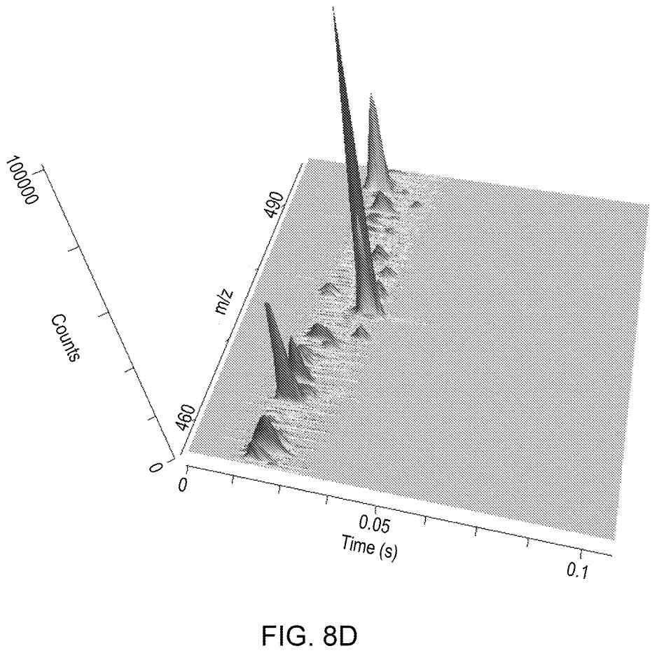

The above described experiment was run again, except in a mode in which the pressure in the separation device was reduced to about 0.25 mbar and the amplitude of the DC voltage travelled along the separation device was changed so as to be ramped from 30V to 54V over the 0.1 second period such that ions having different properties elute from the downstream end of the separation device at different times. FIG. 8A shows a heat map of the ions that were detected by the time of flight mass analyser, in a corresponding manner to FIG. 7A. FIG. 8B is a plot of the same data as in FIG. 8A, except illustrating the total intensity of ions of all mass to charge ratios as a function of time during the 0.1 second period that ions were caused to elute from the separation device. FIG. 8C shows the summed mass spectrum obtained by detecting ions over the entire 0.1 s elution time. FIG. 8D shows a 3D plot of the data from FIG. 8A, for the portion of the data having an elution time from the separation device between 25 ms and 70 ms, and having a mass to charge ratio range from 455-495. It can be determined from this that the ions are substantially not separated in the ion separation device according their charge states, and that they are instead separated predominantly according to mass to charge ratio.

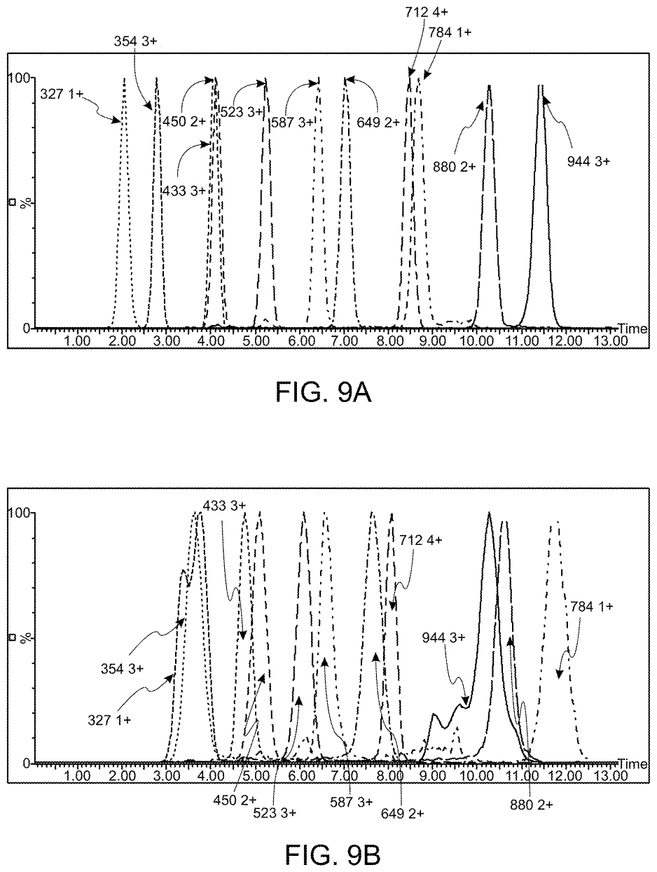

FIG. 9A is an elution time chromatogram, obtained when using the ion separation device in the mode described above in relation to FIGS. 8A-8D, for ion species having the mass to charge ratio values and charge states indicated by the arrows (e.g. “327 1+” indicates an ion species of m/z=327 and charge state of 1+). As can be seen, the eluting peaks are uniformly narrow and elute in order of mass to charge ratio, illustrating that the ion separation device is operating predominantly as a mass to charge ratio separator.

FIG. 9B is an elution time chromatogram, obtained when using the ion separation device in the mode described in relation to FIGS. 7A-7D, for the same ion species shown in FIG. 9A. As can be seen, the elution order of the peaks has changed and now the elution order corresponds to the mobilities of the ions rather than their mass to charge ratios. It can also be seen that the peaks have different widths and shapes to their respective peaks in FIG. 9A, which reflects the fact that multiple conformations of a given ion species have different mobilities in the separation device.

The ion separation device may separate ions predominantly according to mass to charge ratio when the ion separation conditions are such that the ions lose only a relatively small portion of their kinetic energy between being accelerated by subsequent travelling DC potentials. Under such conditions the ions do not reach a mobility-related terminal velocity. Such ion separation conditions include relatively low gas pressures, relatively high speed DC travelling potentials, or the use of a gas in the separation device that has relatively low mass molecules (such as helium or hydrogen). Conversely, the ion separation device may separate ions predominantly according to mobility when the ion separation conditions are such that the travelling DC potentials cause the ions to reach a mobility-related terminal velocity due to collisions with the gas inside the device. Such ion separation conditions include relatively high gas pressures, relatively low speed DC travelling potentials, or the use of a gas in the separation device that has relatively high mass molecules (such as nitrogen).

The ability to easily change the separation condition of the ion separation device has several advantages. For example, it is possible to change the separation condition of the ion separation device as ions elute from the separation device. For instance, a population of ions may be accumulated and isolated in the ion separation device. The ion separation device may then be operated so as to cause ions from the population to elute in order of mobility (or reverse order), and then the ion separation device may then be operated so as to cause ions from the same initial population to elute in order of mass to charge ratio (or reverse order). Alternatively, the ion separation device may operated so as to cause ions from the population to elute in order of mass to charge ratio (or reverse order) and then in order of mobility (or reverse order).

Alternatively, the ion separation device may be operated so as to switch between performing a mobility separation cycle on one population of ions and a mass to charge ratio separation cycle on a different population of ions. For example, the ion separation device may repeatedly alternate between performing a mobility separation cycle and a mass to charge ratio separation cycle. The different cycles may be performed on different populations of ions.

Alternatively, the ion separation device may receive ions from a sample that has been separated by chromatography, and the ion separation device may be operated so as to switch from one of the modes to the other of the modes at one or more pre-selected chromatographic elution times, e.g. so as to separate ions from one or more pre-selected target compounds in the sample according to a pre-selected one or the modes of separation that is desired for such one or more target compounds.

Alternatively, a data dependent acquisition (DDA) may be performed comprising performing a survey scan so as to mass analyse ions from a sample. The DDA method may then switch the ion separation device between the two modes at times that are based on the results of the survey scan, e.g. so that different ion species determined to be present in the survey scan are subjected to different modes of ion separation. Alternatively, a data independent acquisition (DIA) analysis mode may be performed in which the ion separation device between the two modes.

Other embodiments are contemplated in which it is desired to operate the ion separation device in one mode or the other. For example, if the ion separation device is operated predominantly in a mass to charge ratio separation mode and placed upstream of a mass filter, the mass transmission window of the mass filter may be varied in synchronism with the separation cycle of the ion separation device. This allow ions to be mass filtered from the same population with high duty cycle. Alternatively, the ion separation device may be operated predominantly in a mobility separation mode and placed upstream of a fragmentation device so that only multiply charged precursor ions are subjected to MS/MS analysis, or so that multiply charged precursor ions are subjected to MS/MS analysis separately (at a different time) to singly charged ions. This may be useful, for example, in bottom-up proteomics. Alternatively, for applications such as lipidomics and metabolomics where analytes are predominantly singly charged, it may be advantageous to operate the ion separation device predominantly in a mass to charge ratio separation mode. In this case the presence of multiple conformations of a given ion species will not lead to broadening of the ion peak and the elution time of an ion from the ion separation device can be more directly correlated to the set mass of the quadrupole mass filter. As the peaks eluting from the ion separation device are narrower in this mode, this also provides for a higher separation peak capacity. The quadrupole mass filter may be scanned in synchronism with the elution cycle of the ion separation device so as to transmit ions into a fragmentation device such that an MS/MS analysis may be performed with a high duty cycle and without discrimination of different conformations of the same species that have different mobilities.

Embodiments are also contemplated in which the ion separation device is operated so as to separate ions according to a mixture of mobility and mass to charge ratio, i.e. in a mode where the ion separation device does not separate ions predominantly according to mobility or mass to charge ratio. In this mode the gas pressure of the separator, the speed or amplitude of the DC travelling potentials, or the molecular mass of the gas in the separator may be between the corresponding values used in the modes in which the separator separates ions predominantly by mobility and mass to charge ratio. Such embodiments enable ions having different charge states but similar mass to charge ratios to be separated, whilst minimising peak broadening caused by a given ion species having multiple conformations.

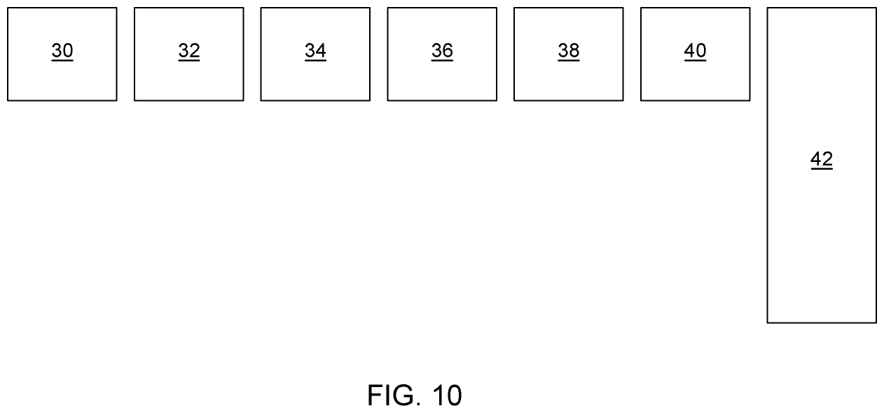

FIG. 10 shows an embodiment in which the ion separation device is operated predominantly as a mass to charge ratio separator. This embodiment comprises an ion source 30 (e.g. at atmospheric pressure), an ion mobility separator (IMS) 32 (e.g. at 2-5 mbar), a mass filter 34 (e.g. at 0.2 mbar), an ion separation device 36 of type described above that is configured to operate predominantly as a mass to charge ratio separator (e.g. at 0.2 mbar), a mass filter 38 (e.g. at 10⁻⁵ mbar), a fragmentation, activation or reaction cell 40 (e.g. at 10⁻² mbar), and a TOF mass analyser 42 (e.g. at 10⁻⁷ mbar).

In use, ions generated by the ion source 30 are transmitted into the IMS device 32, which separates the ions such that they elute in order of mobility or in reverse order of mobility. The ions that elute from the IMS device 32 then pass into the mass filter 34. The mass transmission window of the mass filter may be scanned in synchronism with the separation cycle of the IMS device 32 such that the mass filter 34 filters out singly charged ions but transmits multiply charged ions to the mass to charge ratio separator 36. The multiply charged ions are then separated predominantly according to mass to charge ratio by the mass to charge ratio separator 36 and hence elute in order of mass to charge ratio (or in reverse order). The mass to charge ratio separator 36 reduces the peak width of any given one of the multiply charged ion species because it removes any peak broadening that was caused by different conformations of that species having different mobilities in the IMS device 32. For example, it can be seen from FIGS. 9A-9B that the peak width for the ion species having a mass to charge ratio of 944 and a charge state of 3+ is relatively broad when these ions are separated by mobility, but relatively narrow when separated by mass to charge ratio. The use of the mass to charge ratio separator 36 in this manner therefore allows a greater number of species that elute from the mass to charge ratio separator 36 to be isolated by the downstream quadrupole mass filter 38, thus improving the duty cycle of the instrument.

The mass filter may be operated such that only ions having a restricted range of mass to charge ratios are transmitted to the fragmentation, activation or reaction cell 40 so as to fragment, activate or react the ions to produce fragment or other product ions. The fragment or other product ions may then be mass analysed in the mass analyser 42.

The IMS device 32 may be any type of ion mobility separator, such as any of the types described herein. The IMS device 32 may be operated so as to have a faster ion separation cycle than that of the downstream mass to charge ratio separator 36. As such, the IMS device 32 only ever contains relatively small ion populations, which are then eluted from the IMS device 32 and pass to the mass to charge ratio separator 36. This enables the IMS device 32 to contain only a fraction of the total charge accumulated in the downstream mass to charge ratio separator 36 and so avoids space-charge effects in the IMS device 32.

The mass filter 34 may be a quadrupole mass filter or other type of mass filter. For example, the mass filter 34 may be replaces with a device that has a mass selective RF pseudopotential barrier that prevents singly charged ions from passing from the IMS device 32 to the mass to charge ratio separator 36. A DC voltage gradient may be used in order to drive ions through the relatively high pressure in which the mass filter 34 or mass selective RF pseudopotential barrier is located.

In the embodiments that have been described as including multiple IMS devices (e.g. in series or in parallel), it is contemplated that one of these devices may be operated so as to primarily separate ions according to mobility and another of these devices may be operated so as to primarily separate ions according to mass to charge ratio. This may be enabled by arranging the different devices in separate chambers at different pressures.

Although FIG. 6 was described as having parallel IMS devices 11a, 11b, it is alternatively contemplated that the devices 11a, 11b may be operated so as to primarily separate and elute ions according to mass to charge ratio. This could be achieved by reducing the pressure of these devices, e.g. by arranging deflector 16, separators 11a, 11b and funnel 17 in a different vacuum chamber to the ion guide 15. The separator devices 11a, 11b may be filled with a relatively light gas such as helium, e.g. if the pressure is ≥1 mbar, or the pressure may be reduced to, say, 0.1-0.5 mbar and a gas such as nitrogen may be used as the background gas in the devices 11a, 11b.

1. A method of mass and/or mobility spectrometry comprising:
providing an ion separation device comprising a plurality of electrodes;
providing a first force that urges ions in a first direction along an axis of the ion separation device, whilst also providing a second force that urges ions in a second opposite direction such that ions of different mobility or mass to charge ratio reach different equilibrium positions at different locations along the axis; and
varying the first and/or second force during a single elution cycle of the ion separation device so as to sequentially release ions from said ion separation device in increasing order of ion mobility or mass to charge ratio, or in decreasing order of ion mobility or mass to charge ratio;
wherein said varying step is performed such that ions in a first range of mobilities or mass to charge ratios elute from the ion separation device at a first rate, and ions in a second separate range of mobilities or mass to charge ratios elute from the ion separation device at a second different rate during said elution cycle.

2. The method of claim 1, wherein ions are prevented from entering the ion separation device during said single elution cycle.

3. The method of claim 1 or 2, comprising selecting said first range of mobilities or mass to charge ratios to be mobilities or mass to charge ratios of interest, and selecting said second range of mobilities or mass to charge ratios to be mobilities or mass to charge ratios of less interest, and performing said varying step such that the first rate is slower than the second rate.

4. The method of claim 1, 2 or 3, comprising:
(i) applying voltages to said electrodes so that DC potentials travel along the ion separation device so as to provide the first force that urges the ions in the first direction, and applying voltages to said electrodes so as to provide a DC electric field that provides the second force that urges the ions in the second direction; or
(ii) applying different phases of a periodic or harmonic voltage waveform to different ones of the electrodes so that potentials travel along the ion separation device so as to provide the first force that urges the ions in the first direction, and applying voltages to said electrodes so as to provide a DC electric field that provides the second force that urges the ions in the second direction.

5. The method of claim 4, comprising varying the magnitude of the DC electric field as a function of position along the axis and/or varying at least one operational parameter of the potentials that travel along the ion separation device as a function of position along the axis, such that ions of different mobility or mass to charge ratio become trapped at said different equilibrium positions.

6. The method of any preceding claim, wherein the varying step is performed such that the first and/or second force is varied progressively and substantially continuously so as to cause ions having said first range of mobilities or mass to charge ratios to exit the ion separation device, and wherein the first and/or second force is varied progressively and substantially continuously so as to cause ions having said second range of mobilities to exit the ion separation device.

7. The method of any one of claims 1-5, wherein said varying step is performed such that the first and/or second force is varied progressively and substantially continuously so as to cause ions having said first range of mobilities or mass to charge ratios to exit the ion separation device; and wherein the first and/or second force is varied in a discontinuous and stepped manner so as to cause ions having at least some other mobilities or mass to charge ratios to exit the ion separation device.

8. The method of claim 7, wherein the first and/or second force is varied in a discontinuous and stepped manner so as to cause ions having said second range of mobilities to exit the ion separation device.

9. The method of any preceding claim, comprising providing an ion-optical device downstream of the ion separation device for receiving ions eluting from the ion separation device; wherein the ion-optical device operates in a cyclical manner that is synchronised with the elution cycle of the ion separation device.

10. The method of claim 9, wherein the operation of the ion-optical device is synchronised with the start of the elution cycle, or with the start of the duration over which the first range of mobilities or mass to charge ratios elute from the ion separation device.

11. A method of mass and/or mobility spectrometry comprising:
separating an analytical sample with a chromatography device such that different analytes in the analytical sample have different retention times in the chromatography device;
ionising the analytes downstream of the chromatography device to form ions;
receiving the ions, or ions derived therefrom, in an ion separation device that separates ions by mobility or mass to charge ratio; and
operating the ion separation device so as to repeatedly alternate between: (i) an accumulation mode in which it receives and separates ions by mobility or mass to charge ratio; and (ii) an elution mode in which ions are caused to elute from the ion separation device in increasing or decreasing order of mobility or mass to charge ratio;
wherein the ion separation device is synchronised with the chromatography device such that, during a single separation cycle of the chromatography device, different ones of the accumulation modes and/or different ones of the elution modes are operated differently at different retention times of the chromatography device.

12. The method of claim 11, wherein the ion separation device is operated with different operational parameters in said different accumulation modes so as to confine ions having different mobility or mass to charge ratio ranges in said different accumulation modes.

13. The method of claim 11 or 12, wherein the ion separation device is synchronised with the chromatography device such that during a first elution mode that occurs at a first retention time of the chromatography device, mobilities or mass to charge ratios are caused to elute from the ion separation device at a first rate; and such that during a second elution mode that occurs at a second different retention time of the chromatography device, mobilities or mass to charge ratios are caused to elute from the ion separation device at a second rate.

14. The method of claim 13, wherein the first elution mode occurs over a first duration and the second elution mode occurs over a different duration.

15. The method of any one of claims 11-14, wherein the ion separation device is synchronised with the chromatography separator such that the operation of the ion separation device is varied as a function of the retention time of the chromatography separator in a preselected manner.

16. The method of any one of claims 11-14, comprising performing a survey scan mode in which the analytical sample is separated in the chromatography separator, ionised and the resulting ions, or ions derived therefrom are analysed using the ion separation device so as to determine their mobilities or mass to charge ratios as a function of retention time in the chromatography separator;
selecting ions having a restricted range of the determined mobilities or mass to charge ratios as being target ions of interest; and then
analysing the analytical sample again using the method claimed in any one of claims 11-14, during which the ion separation device is synchronised with a separation cycle of the chromatography separator such that:
(i) at the time the target ions of interest arrive at the ion separation device, the ion separation device is controlled to operate in an accumulation mode that substantially only confines the target ions of interest or that is otherwise optimised for the target ions of interest; and/or
(ii) when the target ions of interest are in the ion separation device, the ion separation device is operated in an elution mode that elutes ions over a longer duration than in elution modes that occur at other retention times of the chromatography device at which the target ions of interest are not expected to be in the ion separation device.

17. The method of any one of claims 11-16, wherein each accumulation mode comprises providing a first force that urges ions in a first direction along an axis of the ion separation device, whilst also providing a second force that urges ions in a second opposite direction such that ions of different mobility or mass to charge ratio reach different equilibrium positions at different locations along the axis; and wherein each elution mode comprises varying the first and/or second force so as to sequentially release ions from said ion separation device in increasing order of ion mobility or mass to charge ratio, or in decreasing order of ion mobility or mass to charge ratio.

18. The method of claim 17, comprising applying voltages to electrodes of the ion separation device so that potentials travel along the ion separation device so as to provide the first force that urges the ions in the first direction, and applying voltages to said electrodes so as to provide a DC electric field that provides the second force that urges the ions in the second direction.

19. The method of claim 18, comprising selecting the magnitude of the DC electric field and/or at least one operational parameter of the travelling potentials that is applied to the ion separation device based on the retention time of the chromatography device.

20. The method of any one of claims 11-19, comprising providing an ion-optical device downstream of the ion separation device for receiving ions eluting from the ion separation device; wherein the ion-optical device operates in a cyclical manner that is synchronised with the elution cycle of the ion separation device.

21. A method of mass and/or mobility spectrometry comprising:
providing an ion separation device comprising a plurality of electrodes;
operating the ion separation device in a first mode in which a DC electric field or travelling potentials are used to urge ions through a substantially stationary background gas such the ions are separated according to mobility through the gas; and
operating the ion separation device in a second mode in which a first force urges ions in a first direction along an axis of the ion separation device, whilst also providing a second force that urges ions in a second opposite direction such that ions of different mobility reach different equilibrium positions at different locations along the axis.

22. The method of claim 21, comprising applying voltages to electrodes of the ion mobility separator so that potentials travel along the ion mobility separator so as to provide the first force that urges the ions in the first direction, and applying voltages to said electrodes so as to provide a DC electric field that provides the second force that urges the ions in the second direction.

23. An ion mobility and/or mass spectrometer configured with control circuitry for performing the method of any preceding claim.

24. A method of mass spectrometry comprising:
providing ions to an ion separation device comprising a plurality of electrodes;
operating the ion separation device under a first set of operating conditions in a first mode such that the ions are separated and elute from the ion separation device according to their mass to charge ratios; and
operating the ion separation device under a second, different set of operating conditions in a second mode such that ions are separated and elute from the ion separation device according to their mobilities;
wherein the ion separation device is switched between the first and second modes during a single experimental run.

25. The method of claim 24, wherein the ion separation device separates ions in each of the first and second modes by:
providing a first force that urges ions in a first direction along an axis of the ion separation device, whilst also providing a second force that urges ions in a second opposite direction such that ions of different mass to charge ratio or mobility reach different equilibrium positions at different locations along the axis; and
varying the first and/or second force so as to cause ions to elute from said ion separation device in increasing order of mass to charge ratio or mobility, or in decreasing order of mass to charge ratio or mobility.

26. The method of claim 25, comprising:
(i) applying voltages to said electrodes so that DC potentials travel along the ion separation device so as to provide the first force that urges the ions in the first direction, and applying voltages to said electrodes so as to provide a DC electric field and/or providing a gas flow so as to provides the second force that urges the ions in the second direction; or
(ii) applying different phases of a periodic or harmonic voltage waveform to different ones of the electrodes so that potentials travel along the ion separation device so as to provide the first force that urges the ions in the first direction, and applying voltages to said electrodes so as to provide a DC electric field and/or providing a gas flow so as to provide the second force that urges the ions in the second direction.

27. The method of any one of claims 24-26, wherein one or more of the following conditions differ in the first set of conditions as compared to the second set of conditions: (i) the gas pressure in the ion separation device; (ii) the gas type in the ion separation device; (iii) the gas composition in the ion separation device; and (iv) the speed that the potentials that travel along the ion separation device.

28. The method of any one of claims 24-27, comprising operating the ion separation device so as to repeatedly perform a cycle that comprises: (i) an accumulation period in which the ion separation device receives ions; and (ii) an elution period in which ions are caused to elute from the ion separation device according to mass to charge ratio or mobility.

29. The method of claim 28, wherein the ion separation device is alternated between the first and second modes during the elution period of a single one of the cycles; or
wherein the ion separation device is operated in the first mode during the elution period of one of the cycles and is operated in the second mode during the elution period of a different one of the cycles.

30. The method of any one of claims 24-29, comprising:
a) performing a survey scan in which ions from an analytical sample are mass and/or mobility analysed;
b) selecting one or more ion species detected in the survey scan as being one or more target ions species of interest;
c) selecting that said one or more target ions species of interest should be analysed using either said first mode or said second mode; and then
d) analysing the analytical sample again using the method claimed in any one of claims 24-29, during which the one or more target ions species of interest are analysed according to the mode selected in step c).

31. A method of mass spectrometry comprising:
separating ions in an ion separation device comprising a plurality of electrodes by providing a first force that urges the ions in a first direction along an axis of the ion separation device, whilst also providing a second force that urges ions in a second opposite direction such that ions of different mass to charge ratio reach different equilibrium positions at different locations along the axis, and varying the first and/or second force so as to perform a separation cycle in which ions are sequentially released from said ion separation device in increasing or decreasing order of mass to charge ratio; and
mass filtering the ions released from the ion separation device in a first mass filter;
wherein the mass transmission window of the first mass filter is scanned and/or stepped in synchronism with the separation cycle of the ion separation device.

32. The method of claim 31, comprising:
(i) applying voltages to said electrodes so that DC potentials travel along the ion separation device so as to provide the first force that urges the ions in the first direction, and applying voltages to said electrodes so as to provide a DC electric field and/or providing a gas flow so as to provide the second force that urges the ions in the second direction; or
(ii) applying different phases of a periodic or harmonic voltage waveform to different ones of the electrodes so that potentials travel along the ion separation device so as to provide the first force that urges the ions in the first direction, and applying voltages to said electrodes so as to provide a DC electric field and/or providing a gas flow so as to provide the second force that urges the ions in the second direction.

33. The method of claim 31 or 32, comprising separating ions according to mobility in an ion mobility separator, supplying the mobility separated ions to said ion separation device and then performing said step of separating ions in the ion separation device.

34. The method of claim 33, wherein said ions include one or more ion species having multiple different conformers that have different respective mobilities.

35. The method of claim 33 or 34, comprising mass filtering the ions between the ion mobility separator and the ion separation device using a second mass filter such that only ions having a restricted mass to charge ratios and mobilities in restricted ranges are transmitted to the ion separation device.
